(19) United States
(12) Patent Application Publication
(10) Pub. No.: US 2026/0101390 A1
(43) Pub. Date: Apr. 9, 2026

(54) METHODS, ARCHITECTURES, APPARATUSES AND SYSTEMS FOR MEDIUM ACCESS CONTROL (MAC) ADDRESS CONFLICT RESOLUTION FOR MULTI-HOP RELAYING

(71) Applicant: InterDigital Patent Holdings, Inc, Wilmington, DE (US)

(72) Inventors: Taimoor Abbas, Sainte-Julie (CA); Jung Je Son, Warrington, PA (US); Samir Ferdi, Kirkland (CA)

(21) Appl. No.: 18/905,640

(22) Filed: Oct. 3, 2024

(51) Int. Cl. H04W 76/14; H04L 61/50; H04L 101/622; H04W 92/18

(52) U.S. Cl. CPC H04W 76/14; H04L 61/50; H04L 2101/622; H04W 92/18

(57) ABSTRACT

A first WTRU-to-WTRU relay WTRU (relay WTRU) may receive, from a second relay WTRU, a direct connection request message. The first relay WTRU may send, to the second relay WTRU, a direct security mode command message. The first relay WTRU may receive, from the second relay WTRU, a direct security mode complete message including (i) a first MAC address of a source-end WTRU, and/or (ii) a first MAC address of the second relay WTRU. The first relay WTRU may send, to the second relay WTRU, a PC5-S request message indicating the first MAC address of the source-end WTRU and/or the first MAC address of the second WTRU-to-WTRU relay WTRU conflicts with another MAC address. The first relay WTRU may receive, from the second relay WTRU, a PC5-S response message including (i) a second MAC address of the source-end WTRU, and/or (ii) a second MAC address of the second relay WTRU.

### BACKGROUND

The present application is related to the fields of communications, software and encoding, including, for example, to methods, architectures, apparatuses, systems directed to MAC address conflict resolution for multi-hop wireless transmit/receive unit-to-wireless transmit/receive unit (WTRU-to-WTRU) relays.

### BRIEF SUMMARY

In certain representative embodiments, end-to-end link establishment may be performed between a source end (S-end) WTRU and a target end (T-end) WTRU via a plurality of intermediate WTRU-to-WTRU relays (U2U WTRUs). For example, the end UEs and all intermediate U2U relays may exchange their MAC addresses via the multi-hop U2U relays, such as for ethernet traffic using multi-hop U2U relay communications. There is a possibility that one or more MAC address may be in conflict (e.g., same MAC address used by multiple WTRUs). A WTRU (e.g., U2U relay WTRU) may detect a conflict in the MAC addresses, may be unable to determine which of the two UEs should receive IP traffic as both have the same MAC address. In situations where the MAC addresses of one or more UEs in a multi-hop U2U relay connection are in conflict (e.g., the same, non-unique), detection and resolution of the MAC address conflict may be performed, such as at the time of (e.g., during) connection establishment request and at the time of (e.g., during) connection establishment accept messaging.

In certain representative embodiments, MAC address conflict resolution may be performed during direct connection establishment requesting.

In certain representative embodiments, a first U2U relay WTRU (e.g., a U2U Relay #2) may receive a Direct Connection Request (DCR) message from a second U2U relay WTRU (e.g., a U2U Relay #1), such as for Ethernet traffic. The first U2U relay WTRU may send a Direct Security Mode (DSM) Command message to the second U2U relay WTRU. The first U2U relay WTRU may receive a DSM Complete message (e.g., from the second U2U relay WTRU. For example, the DSM Complete message may include a MAC address of a S-end WTRU and a MAC address of the second U2U relay WTRU. The first U2U relay WTRU may detect a conflict with respect to the MAC address of the S-end WTRU and/or with respect to the MAC address of the second U2U relay WTRU.

Briefly stated, in one embodiment, the first U2U relay WTRU may send a PC5-S request message to the second U2U relay WTRU. For example, the PC5-S request message may include information indicating any of a MAC address conflict, and a WTRU identifier (ID) and/or MAC address for which a conflict has been identified (e.g., the S-end WTRU or second U2U relay WTRU). The first U2U relay WTRU may receive a PC5-S response message from the second U2U relay WTRU which includes a (e.g., new and/or different) MAC address for the S-end WTRU and/or the second U2U relay WTRU. The first U2U relay WTRU may validate (e.g., determine whether a conflict exists) the MAC address(es) with respect to the MAC address of the S-end WTRU and/or with respect to the MAC address of the second U2U relay WTRU.

In one embodiment, the first U2U relay WTRU may allocate a (e.g., new and/or different) MAC address for the second U2U relay WTRU and/or the S-end WTRU. The first U2U relay WTRU may send a PC5-S message to the second U2U relay WTRU that includes information indicating a MAC address conflict and the allocated MAC address(es) for the second U2U relay WTRU and/or the S-end WTRU. The first U2U relay WTRU may receive an acknowledgment from the second U2U relay WTRU that includes information indicating the allocated MAC address(es) for the second U2U relay WTRU and/or the S-end WTRU is updated.

In one embodiment, the first U2U relay WTRU may allocate a (e.g., new and/or different) MAC address for the second U2U relay WTRU and/or the S-end WTRU. The first U2U relay WTRU may use the allocated MAC address in following hops to establish the PC5 link with the T-end WTRU. Based on (e.g., upon) reception of a first Direct Communication Accept (DCA) message (e.g., from another hop), the first U2U relay WTRU may send a (e.g., second) DCA message to the second U2U relay WTRU. The DCA message to the second U2U relay WTRU may include information indicating the allocated MAC address and MAC address conflict to inform the second U2U relay WTRU and/or the S-end WTRU of the conflicting MAC address.

In one embodiment, the first U2U relay WTRU may send a Direct Communication Reject message to the second U2U relay WTRU. For example, the Direct Communication Reject message may include information indicating a MAC address conflict and a WTRU ID associated with the conflicting MAC address (e.g., ID of the S-end WTRU or second U2U relay WTRU). As an example, the Direct Communication Reject message may include a cause (e.g., code) indicating “MAC address not unique” and an ID of the WTRU associated with the conflicting MAC address.

In certain representative embodiments, a first U2U relay WTRU (e.g., a U2U Relay #1) may receive a Direct Connection Request (DCR) message from a S-end WTRU, such as for Ethernet traffic. The first U2U relay WTRU may send a DSM Command message to the S-end WTRU. The first U2U relay WTRU may receive a DSM Complete message (e.g., from the S-end WTRU) which includes information indicating a (e.g., first) MAC address of the S-end WTRU.

Briefly stated, in one embodiment, the first U2U relay WTRU may detect a conflict with respect to the MAC address of the S-end WTRU (e.g., non-unique MAC address). The first U2U relay WTRU may send a DC Reject message to the S-end WTRU which includes information indicating a MAC address conflict, such as a cause (e.g., code) “MAC address not unique”.

In one embodiment, the first U2U relay WTRU may detect no conflict with respect to the MAC address of the S-end WTRU, and may send a DCR message to a second U2U relay WTRU (e.g., a U2U Relay #2) which includes the MAC address of the S-end WTRU and a (e.g., second) MAC address of the first U2U relay WTRU.

In one embodiment, the first U2U relay WTRU may receive a PC5-S request message from the second U2U relay WTRU. For example, the PC5-S request message may include information indicating a MAC address conflict and a WTRU ID and/or MAC address associated with the MAC address conflict (e.g., ID of the first U2U relay WTRU and/or S-end WTRU). The first U2U relay WTRU may determine whether the MAC address conflict is for the first U2U relay WTRU or the S-end WTRU. For example, if the MAC address conflict is for the MAC address of the first U2U relay WTRU, the first U2U relay WTRU may update its MAC address and mapping table with its updated MAC address. For example, if the MAC address conflict is for the MAC address of the S-end WTRU, the first U2U relay WTRU may send a PC5-S request message to the S-end WTRU to request a (e.g., new or updated) MAC address from the S-end WTRU. The first U2U relay WTRU may (e.g., also) send a PC5-S response message to the second U2U relay WTRU which includes the (e.g., new or updated) MAC address of the first U2U relay WTRU and/or S-end WTRU.

In one embodiment, the first U2U relay WTRU may receive a PC5-S request message to receive a (e.g., new or updated) MAC address from the second U2U relay WTRU. The PC5-S request message may include information indicating a MAC address conflict and an allocated (e.g., new or updated) MAC address for the first U2U relay WTRU and/or the S-end WTRU. The first U2U relay WTRU may determine whether the allocated MAC address is for itself (e.g., first U2U relay WTRU) or the S-end WTRU, such as based on the information in the PC5-S request message. For example, if the allocated MAC address is for the first U2U relay WTRU, the first U2U relay WTRU may update its MAC address. For example, if the allocated MAC address is for the S-end WTRU, the first U2U relay WTRU may send a PC5-S request message to the S-end WTRU to provide the allocated MAC address to the S-end WTRU. The first U2U relay WTRU may update its mapping table with the allocated MAC address (e.g., for the first U2U relay WTRU or the S-end WTRU), and may send an acknowledgment (e.g., of the MAC address update) to the second U2U relay WTRU.

In one embodiment, the first U2U relay WTRU may receive a DCA message from the second U2U relay WTRU. The DCA message may include information indicating a MAC address conflict and an (e.g., new or updated) allocated MAC address. For example, the DCA message may inform the first U2U relay WTRU that the first U2U relay WTRU and/or the S-end WTRU has a conflicting MAC address (e.g., and to update to the allocated MAC address). The first U2U relay WTRU may update its mapping table with the allocated MAC address, and provide the allocated MAC address to the S-end WTRU.

In one embodiment, the first U2U relay WTRU may send a DC Reject message to the S-end WTRU. For example, the DC Reject message may include information indicating a MAC address conflict. For example, the DC Reject message ma include a cause (e.g., code) “MAC address not unique” and information indicating a WTRU ID associated with the MAC address conflict (e.g., the first U2U relay WTRU and/or the S-end WTRU).

In certain representative embodiments, MAC address conflict resolution may be performed during direct connection establishment acceptance.

In certain representative embodiments, a first U2U relay WTRU (e.g., a U2U Relay #2) may receive a Direct Connection Accept (DCA) message from a second U2U relay WTRU (e.g., a U2U Relay #3), such as for Ethernet traffic. The DCA message may include information indicating a (e.g., first) MAC address for a S-end WTRU, a (e.g., second) MAC address for a T-end WTRU, and a (e.g., third) MAC address for the second U2U relay WTRU. The first U2U relay WTRU may update its mapping table to include the MAC address of the T-end WTRU. The first U2U relay WTRU may detect the MAC address is in conflict (e.g., not unique) for any of the T-end WTRU and/or the second U2U relay WTRU.

Briefly stated, in one embodiment, the first U2U relay WTRU may block traffic to and/or from this PC5 link, and may send a Link Modification Request message to the second U2U relay WTRU. For example, the Link Modification Request message may include any of an operation code indicating MAC address conflict (e.g., “get new MAC address”), a cause code indicating MAC address conflict (e.g., “MAC address not unique”), and/or information indicating whether the MAC address conflict is detected for the MAC address of the second U2U relay WTRU and/or the T-end WTRU. The first U2U relay WTRU may receive information indicating a (e.g., new or updated) MAC address and update its mapping table accordingly.

In one embodiment, the first U2U relay WTRU may use the detection of the MAC address conflict as a trigger for a Link Identifier Update (LIU) procedure. For example, the first U2U relay WTRU may send a Link Identifier Update Request message to the second U2U relay WTRU which includes information indicating whether the MAC address conflict is associated with the respective MAC address of the second U2U relay WTRU or the T-end WTRU (or both). For example, the first U2U relay WTRU may include a (e.g., updated or suggested) MAC address for the second U2U relay WTRU or the T-end WTRU (or both). The first U2U relay WTRU may receive a LIU Response message including a (e.g., new or updated) MAC address (e.g., from the second U2U relay WTRU) and may update its mapping table accordingly.

In one embodiment, the first U2U relay WTRU may send a Link Release Request message to the second U2U relay WTRU. The Link Release Request message may include a cause code (e.g., “MAC address not unique”) and information indicating whether the MAC address conflict is detected for the respective MAC address of the second U2U relay WTRU or the T-end WTRU (or both). The first U2U relay WTRU may receive a Link Release Response message from the second U2U relay WTRU. The first U2U relay WTRU may send (e.g., another) DCR message to the T-end WTRU (e.g., via the second U2U relay WTRU) which includes a (e.g., new or updated) MAC address, such as for the second U2U relay WTRU or the T-end WTRU.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1A is a system diagram illustrating an example communications system, according to one or more embodiments of the present disclosure;

FIG. 1B is a system diagram illustrating an example wireless transmit/receive unit (WTRU) that may be used within the communications system illustrated in FIG. 1A, according to one or more embodiments of the present disclosure;

FIG. 1C is a system diagram illustrating an example radio access network (RAN) and an example core network (CN) that may be used within the communications system illustrated in FIG. 1A, according to one or more embodiments of the present disclosure;

FIG. 1D is a system diagram illustrating a further example RAN and a further example CN that may be used within the communications system illustrated in FIG. 1A, according to one or more embodiments of the present disclosure;

FIG. 2 is a procedural diagram illustrating an example PC5 unicast link establishment procedure between a source-end (S-end) WTRU and a target-end (T-end) WTRU via a Layer 3 U2U relay, according to one or more embodiments of the present disclosure;

FIG. 3 is a procedural diagram illustrating various examples of MAC address conflict resolution during connection establishment requesting, according to one or more embodiments of the present disclosure;

FIG. 4 a procedural diagram illustrating various examples of MAC address conflict resolution during connection establishment acceptance, according to one or more embodiments of the present disclosure;

FIG. 5 a procedural diagram illustrating various examples of MAC address conflict resolution when a direct link is reused, according to one or more embodiments of the present disclosure;

FIG. 6 a procedural diagram illustrating an example of MAC address conflict resolution during connection establishment requesting, according to one or more embodiments of the present disclosure;

FIG. 7 a procedural diagram illustrating an example of MAC address conflict resolution during connection establishment requesting, according to one or more embodiments of the present disclosure;

FIG. 8 a procedural diagram illustrating another example of MAC address conflict resolution during connection establishment requesting, according to one or more embodiments of the present disclosure;

FIG. 9 a procedural diagram illustrating another example of MAC address conflict resolution during connection establishment requesting, according to one or more embodiments of the present disclosure;

FIG. 10 a procedural diagram illustrating an example of MAC address conflict resolution during connection establishment acceptance, according to one or more embodiments of the present disclosure;

FIG. 11 a procedural diagram illustrating another example of MAC address conflict resolution during connection establishment acceptance, according to one or more embodiments of the present disclosure;

FIG. 12 a procedural diagram illustrating another example of MAC address conflict resolution during connection establishment acceptance, according to one or more embodiments of the present disclosure;

FIG. 13 a procedural diagram illustrating another example of MAC address conflict resolution during connection establishment acceptance, according to one or more embodiments of the present disclosure;

FIG. 14 a procedural diagram illustrating an example of MAC address conflict resolution when a direct link is reused, according to one or more embodiments of the present disclosure;

FIG. 15 a procedural diagram illustrating another example of MAC address conflict resolution when a direct link is reused, according to one or more embodiments of the present disclosure;

FIG. 16 a procedural diagram illustrating another example of MAC address conflict resolution when a direct link is reused, according to one or more embodiments of the present disclosure;

FIG. 17 a procedural diagram illustrating an example of MAC address conflict resolution, according to one or more embodiments of the present disclosure; and

FIG. 18 a procedural diagram illustrating another example of MAC address conflict resolution, according to one or more embodiments of the present disclosure.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

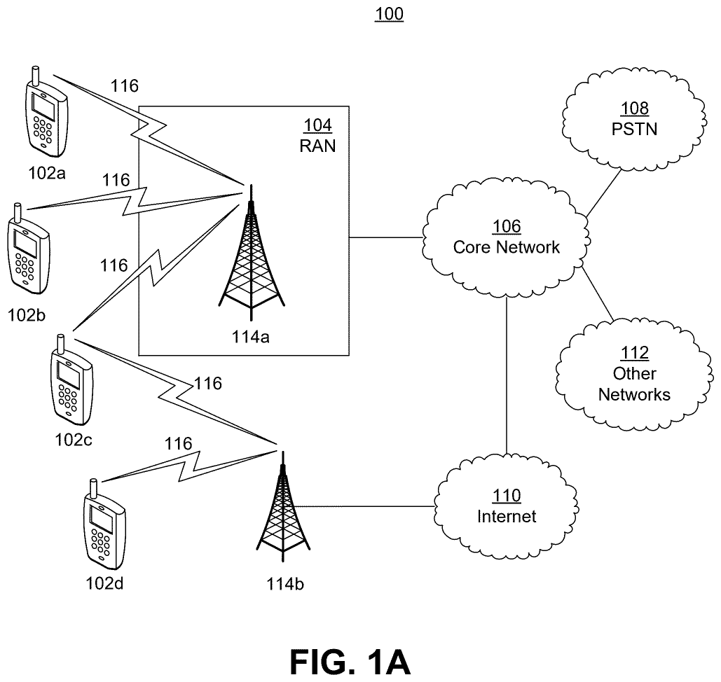

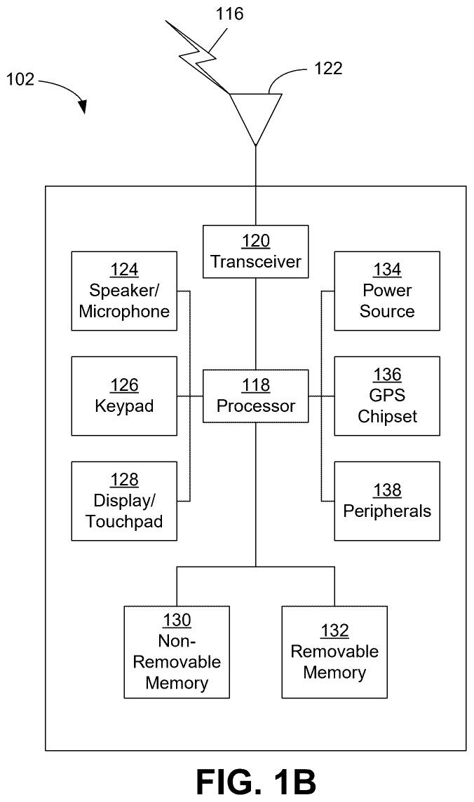

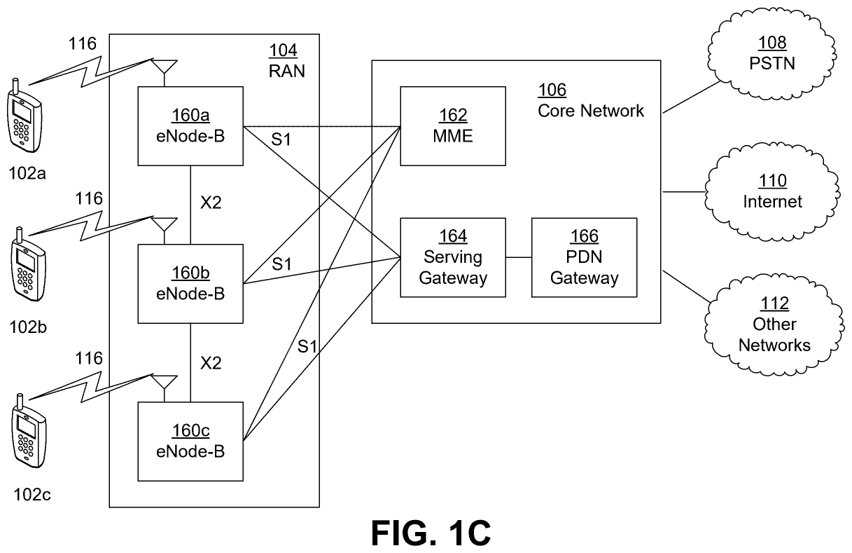

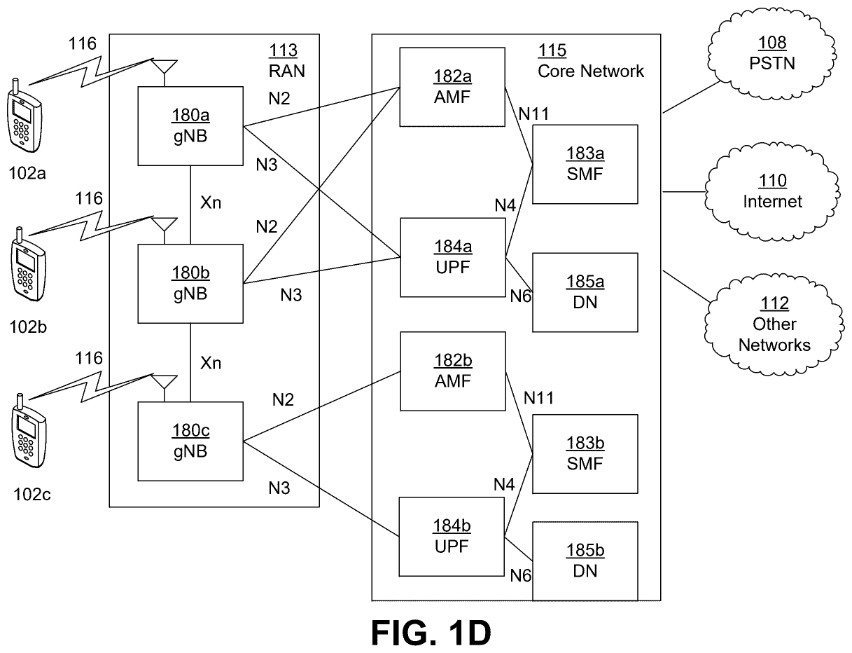

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

The following abbreviations and acronyms may be used herein:
DC Direct Communication
DCR Direct Communication Request
LM Link Modification
LMR Link Modification Request
LR Link Release

As used herein, the terms “relay” and “UE-to-UE (U2U) relay”, “5G Prose Layer-3 U2U relay”, “WTRU-to-WTRU relay” and “relay WTRU” may be used interchangeably. For example, a relay 1 (or #1), relay 2 (or #2), . . . , etc. may refer to a U2U relay #1, a U2U relay #2, and so forth, such as for multi-hop U2U relay communication.

As used herein, “End UE” and “5G ProSe End UE” may be used interchangeably. For example, an End UE may refer to any of a Source End (S-End) UE and/or a Target End (T-End) UE.

### PC5 Unicast Link Establishment

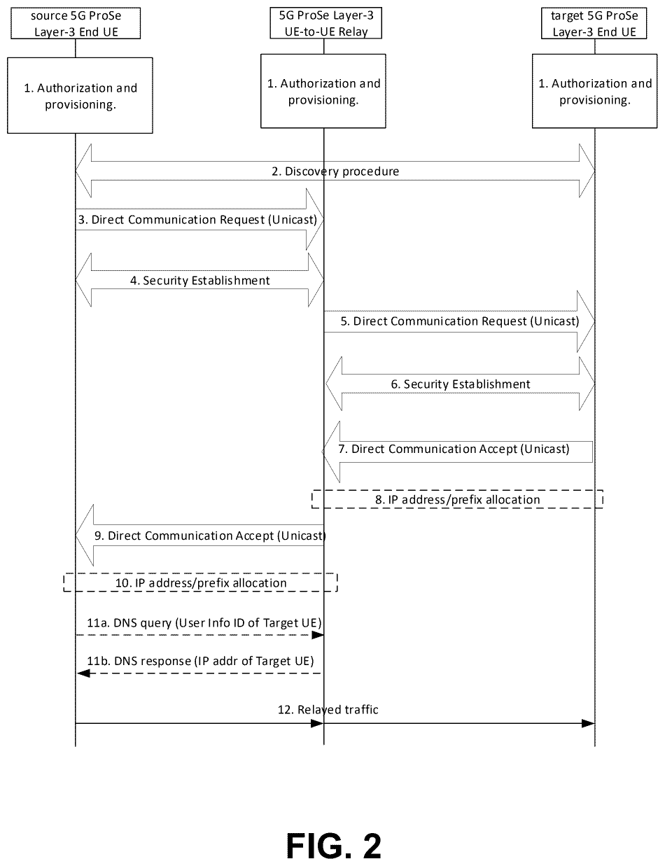

FIG. 2 is a procedural diagram illustrating an example PC5 unicast link establishment procedure between a S-end WTRU and a T-end WTRU via a Layer 3 U2U relay, according to one or more embodiments of the present disclosure.

At 1. in FIG. 2, service authorization and provisioning are performed for the S-end WTRU, the T-end WTRU, and the Layer 3 U2U relay (e.g., WTRU).

At 2., the S-end UE may perform discovery of the U2U relay.

At 3., the S-end may send a Direct Communication Request (DCR) message to initiate the unicast Layer-2 link establishment procedure with the U2U Relay.

If the PC5 link is used for transferring Ethernet traffic, the S-end UE may send its Ethernet MAC address to the U2U relay after security protection is enabled at 4., such as by using a DSM Complete message. If the Ethernet MAC address already used by another (e.g., end) WTRU, then the U2URelay may send a message to the S-end UE indicating there is an Ethernet MAC address conflict.

After the security establishment procedure between the S-end UE and the U2U Relay is completed at 4., the U2U relay may send a Direct Communication Request message at 5. to initiate the unicast Layer-2 link establishment procedure.

At 6., the T-end UE may respond by establishing the security with the U2U Relay. The U2U Relay may send the Ethernet MAC address of the S-end UE to the T-end UE after security protection is enabled at 6., such as by using a DSM Complete message.

At 7., the T-end UE may send a Direct Communication Accept (DCA) message to the U2U Relay that the T-end UE has successfully established security with. The T-end UE may include its MAC address in the DCA message.

At 8., for IP traffic, an IPv6 prefix or IPv4 address may be allocated for the T-end UE.

After receiving the Direct Communication Accept message from the T-end UE, the U2U Relay sends a Direct Communication Accept message to the S-end UE that has successfully established security with. The Relay may include the T-end UE MAC address in the DCA message at 9.

At 10., for IP traffic, an IPv6 prefix or IPv4 address may be allocated for the S-end UE.

For Ethernet communication, the U2U Relay maintains the association between PC5 links and Ethernet MAC addresses received from the End UE(s).

For IP communication, the U2U Relay may store an association of user info (e.g., Application Layer ID) and the IP address of T-end UE into its DNS entries and the U2U Relay may act as a DNS server to other UEs.

At 12., the S-end UE communicates with the T-end UE via the U2U Relay.

### U2U Relay Discovery and PC5 Setup

5G Proximity Service (ProSe) includes several features and procedures such as 5G ProSe Direct Discovery, 5G ProSe Direct Communication, 5G ProSe UE-to-Network Relay, and 5G ProSe UE-to-UE Relay.

5G ProSe UE-to-UE Relay enables indirect communication between two End UEs. For UE-to-UE Relay, 5G ProSe UE-to-UE Relay Discovery and 5G ProSe Communication via UE-to-UE Relay are defined.

For 5G ProSe UE-to-UE Relay Discovery, both Model A and Model B discovery are supported:
Model A uses a single discovery protocol message (Announcement); and
Model B uses two discovery protocol messages (Solicitation and Response).

During 5G ProSe UE-to-UE Relay Discovery, information of two End UEs are shared between the two End UEs to identify the discoverer End UE and discoveree End UE but the information of the two End UEs are protected between the two End UEs and are transparent to the UE-to-UE Relays. Therefore the UE-to-UE Relay cannot acquire and identify information of the End UEs and cannot utilize this information for routing discovery or other signaling message, or for other purposes.

5G ProSe Communication via a UE-to-UE Relay is possible with a Layer 2 UE-to-UE Relay or a Layer 3 UE-to-UE Relay. For a Layer 2 UE-to-UE Relay and a Layer 3 UE-to-UE

Relay, 5G ProSe communication setup with discovery procedures are defined. For example, discovery which is integrated into PC5 unicast link establishment procedure is also defined.

With a Layer 2 UE-to-UE Relay, an end-to-end PC5 link is established between the End UEs, via the U2U Relay. PC5-S messages may then be exchanged between the End UEs.

With a Layer 3 UE-to-UE Relay, each End UE establishes a PC5 link with the Relay and the Relay forwards messages towards the End UEs. PC5-S messages are exchanged between the End UEs and the Relay.

With a Layer 3 UE-to-UE Relay, when an IP-based data connection is used, after PC5 link setup with the U2U Relay, each End UE can be assigned an IP address by the U2U Relay which is based on a DHCP mechanism, or each End UE can assign its own IP address, which is based on a link local IP address assignment mechanism and informed to the Relay. Whether DHCP or link local IP address assignment is to be used is determined during security connection setup between the end UE and the UE-to-UE Relay.

### Multi-Hop for U2N and U2U Relays

Proposals in 3GPP to study potential enhancements to support multi-hop for U2N and U2U relay in Rel-19 are being discussed (e.g., 3GPP TR 23.700-03).

Multi-hop for a UE-to-Network (U2N) Relay is to enable a Remote UE to discover and communicate with a U2N Relay via one or more U2U relays. Multi-hop U2U Relay is to enable End UEs to discover and communicate with each via more than one U2U Relay.

The multi-hop capability is deemed crucial for mission critical communications (e.g., first responders) and in general may be needed to enhance coverage (e.g., indoors).

Existing procedures allow the establishment of a PC5 link between a Source End UE (S-End UE) and a Target End UE (T-End UE) via a Relay in a single hop configuration. As described in above, if the PC5 link is used for transferring Ethernet traffic, the S-End UE sends its Ethernet MAC address to the UE-to-UE (U2U) Relay, and the U2U relay sends the Ethernet MAC address of the S-End UE to the T-End UE, after the security protection is enabled, such as using the Direct Security Mode (DSM) Complete message. Similarly, the T-End UE sends a Direct Communication Accept (DCA) message to the U2U Relay, that has successfully established security with the T-End UE, which includes its MAC address in the DCA message. If the MAC address of the S-End UE or the T-End UE is detected to be the same as any other UE, then the U2U-Relay may reject the DCR message or release the established link, respectively (e.g., 3GPP TS 23.304).

### Mobile Ad-Hoc Network (MANET)

Internet Engineering Task Force (IETF) developed technology for supporting a mobile ad hoc network (MANET). Each router in a MANET discovers other routers by exchanging HELLO messages and each router can determine its 1-hop and 2-hop neighbors based on the exchanged HELLO messages (e.g., RFC 61300). Each router stores a list of its 1-hop and 2-hop neighbors so that the MANET routing protocol may utilize the information.

MANET routing is based on Optimized Link State Routing (OLSR) Protocol. Each router exchanges their topology information with other routers in the network regularly. Each router selects two sets of Multi-Point Relays (MPRs), each being a set of its neighbor routers that cover all of its connected 2-hop neighbor routers. These two sets are “flooding MPRs” and “routing MPRs”, which are used to achieve flooding reduction and topology reduction, respectively. Flooding reduction is achieved by control traffic being flooded through the network using hop-by-hop forwarding, but with a router only needing to forward control traffic that is first received directly from one of the routers that have selected it as a flooding MPR. Topology reduction is achieved by assigning a special responsibility to routers selected as routing MPRs when declaring link state information. Routers not selected as routing MPRs need not send any link state information.

Multi-Hop U2U Relay with MANET

In order to support multi-hop ProSe U2U relays, each relay supporting multi-hop ProSe UE-to-UE relay functionality may form a collocated MANET router functionality that connect with neighboring MANET routers and establishes a mobile ad-hoc network as defined in MANET (e.g., RFC 7181). 5G ProSe communication can be used for communication between two UE-to-UE relays acting as MANET routers and all MANET messages exchanged between UE-to-UE relays may be considered as data traffic over the PC5 user plane interface.

### Overview

In certain representative embodiments, ProSe may be enhanced further to support multi-hop communication for both U2N relay and for U2U relay.

In 3GPP Release-18, a single-hop U2U Relay communication for Ethernet and Unstructured PDU types is supported for PC5 protocol, which can be enhanced to support Layer 3 multi-hop U2U Relays for Ethernet and Unstructured PDU types, utilizing the architecture and protocol for single-hop U2U relay communication. During the E2E multi-hop connection setup, as more nodes (e.g., Relays) are involved, there is a higher possibility of encountering a situation of conflicting MAC addresses among the End UEs and various U2U Relays, than in the single-hop scenario. It may be beneficial to detect and handle MAC address conflicts.

In certain representative embodiments, one or more (e.g., U2U) relays may perform procedures to ensure a S-end UE has a MAC address which is not in conflict.

In certain representative embodiments, one or more (e.g., U2U) relays may perform procedures to ensure a T-end UE has a MAC address which is not in conflict.

In certain representative embodiments, one or more (e.g., U2U) relays may perform procedures to ensure a parent and/or a child U2U UE has a MAC address which is not in conflict.

In certain representative embodiments, procedures may be performed for multi-hop U2U relay communication establishment over an existing link (e.g., already established between an End UE and a Relay or between Relays), such as when an existing single hop link is reused for multiple E2E communication paths, to ensure a MAC address is not in conflict.

For transferring ethernet traffic over ProSe multi-hop communication, a S-End UE, a T-End UE, and (e.g., all) the U2U Relays may share their MAC addresses during connection establishment. The communication between U2U Relays uses the MAC addresses of the U2U Relays involved in the E2E multi-hop link. Each UE may manage a mapping table, which includes the user information of the End UEs and user information of the U2U Relays as well as the MAC addresses of the UEs. The IP addresses of the UE(s) may also be saved in the mapping table. E2E multi-hop U2U relay communication may be performed using (e.g., based on) the mapping table(s).

The solutions presented in this document are based on the possibility that the MAC addresses of one or more UEs in a multi-hop U2U relay connection are the same (non-unique). The solutions are presented to detect and resolve such MAC address non-uniqueness conflicts. As such, the solutions provide means for efficient and reliable link establishment for End UEs and Relays by mitigating potential MAC address conflicts. In this document, a Relay, U2U relay, UE-to-UE Relay 5G Prose Layer-3, and UE-to-UE Relay may be used interchangeably.

In this document, end UE and 5G ProSe end UE may be used interchangeably. End UE include both Source-End (S-End) UE and the Target-End (T-End) UE.

In certain representative embodiments, it may be assumed that the end UEs and the (e.g., all) intermediate U2U relays exchange their MAC addresses via multi-hop U2U relays, such as for ethernet traffic using multi-hop U2U relay communication. There may be a possibility that one or more MAC addresses are in conflict (e.g., the same or non-unique). In cases of MAC address conflict, a detecting UE (e.g., U2U relay) may be unable to determine which of the two UEs should receive the IP traffic as both have the same MAC addresses (e.g., without resolving the MAC address conflict).

In certain representative embodiments, a detecting UE may determine that the MAC addresses of one or more UEs in a multi-hop U2U relay connection are the same (e.g., non-unique). In certain representative embodiments a (e.g., U2U relay) UE may detect and resolve such MAC address non-uniqueness conflicts.

In certain representative embodiments, MAC address conflict resolution may be performed with respect to (e.g., during) a connection establishment request (e.g., message). In certain representative embodiments, MAC address conflict resolution may be performed with respect to (e.g., during) a connection establishment accept (e.g., message).

### MAC Address Conflict Resolution During Connection Establishment Request

In certain representative embodiments, a MAC address conflict may be detected and resolved when connection establishment is initiated by a S-end UE via a multi-hop U2U relay.

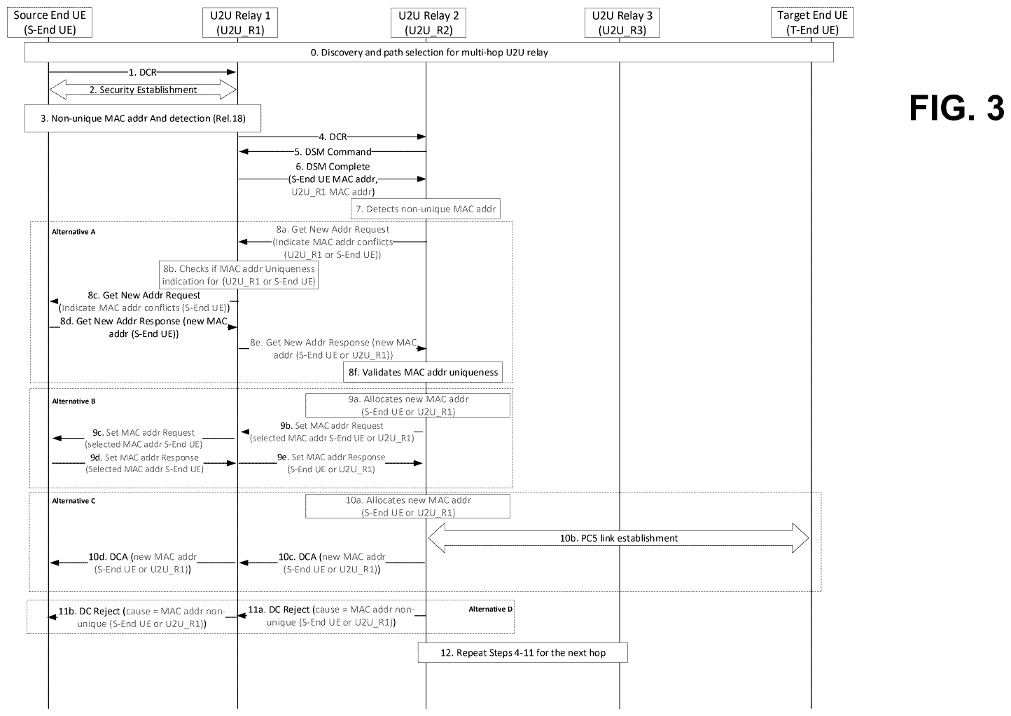

FIG. 3 is a procedural diagram illustrating various examples of MAC address conflict resolution during connection establishment requesting, according to one or more embodiments of the present disclosure.

In certain representative embodiments, such as in FIG. 3, it may be assumed that all the UEs involved in the E2E link establishment are capable of multi-hop U2U relay communication. It may be assumed that the UEs have successfully registered, received confirmation and provisioning from the network. It may be assumed that the S-End UE and T-End UE have discovered each other via multiple U2U-Relay(s) at 0. in FIG. 2.

At 1., the S-End UE may initiate the multi-hop link establishment procedure by sending a Direct Communication Request (DCR) message to the nearest U2U relay (e.g., U2U Relay 1) UE for Ethernet traffic.

At 2., a MAC address of the S-End UE may be sent in a Direct Security Mode (DSM) complete message. At 3., if non-uniqueness is detected at the first hop, then the first U2U relay (e.g., U2U_R1) can reject the direct link establishment by sending a direct communication reject message to the S-End UE (e.g., see 3GPP TS 24.554).

Upon reception of the DSM complete message from the S-End UE (e.g., at 2), and if a MAC address conflict (e.g., non-uniqueness) is not detected at the first U2U relay (e.g., at 3.), then the first U2U relay may create or update its mapping table which includes the MAC address and the user information of the S-End UE and the first U2U relay. At 4., the first U2U relay may send a DCR message to the second U2U relay (e.g., U2U_R2) which triggers the second U2U relay to initiate a security establishment procedure with the first U2U relay by sending a DSM command message at 5.

At 6., upon reception of the DSM command message, the first U2U relay may send the MAC address of the S-End UE and/or the MAC address of the first U2U relay in a Direct Security Mode (DSM) complete message.

At 7., the second U2U relay may create or update its mapping table to respectively include the MAC addresses and the user information of the S-End UE, the first U2U relay, and the second U2U relay. For example, the second U2U relay may determine whether a MAC address conflict exists with respect to the MAC addresses (e.g., a non-uniqueness check on the MAC addresses to ensure the uniqueness of the MAC addresses), such that no two MAC addresses saved at the second U2U relay are the same as the received MAC address(es). The second U2U relay may (e.g., in some cases) detect that a received MAC address of the S-End UE (and/or the first U2U relay) is in conflict (e.g., non-unique) with the MAC address of another end UE or relay UE. The second U2U relay may perform MAC address resolution of the conflicting MAC address(es), such as by using any of the following example procedures (e.g., Alternative A, B, C or D in FIG. 3).

As shown in alternative A in FIG. 3, at 8a., the second U2U relay may send a PC5-S request message (e.g., a Get New Address request) to request a new MAC address to the first U2U relay, which includes an indication of MAC address conflict and includes the UE ID for which the MAC address conflict is identified (e.g., an ID of the U2U_R1 and/or an ID of the S-End UE). For multi-hop scenarios, it may be important to clarify, which of the UE's MAC address is conflicting (e.g., not unique). For example, the UE information may be provided as part of an indication. The second U2U relay may include in the message the conflicting MAC address(es).

At 8b., the first U2U relay receives the indication of the MAC address conflict and the UE ID. Based on that, the first U2U_R1 may determine whether it is for the first U2U relay or the S-End UE (or both). If the MAC address of the first U2U relay is indicated as conflicting, the first U2U relay may update its MAC address, and sends the updated MAC address back to the second U2U relay. If MAC address of the S-End UE is indicated as conflicting, the first U2U relay proceeds with steps 8c. and 8d., otherwise steps 8c. and 8d. may be skipped.

At 8c. and 8d., if the first U2U relay determines the indication of MAC address conflict is for the S-End UE, the first U2U relay may send a PC5-S request message to request a (e.g., new) MAC address to the S-End UE.

In some embodiments, the S-End UE MAC address may have priority and therefore it may never be requested to update its (e.g., S-End UE MAC address) if its MAC address is found to be in conflict with any of the U2U relays. For example, the detecting UE may request the other UE (e.g., the first U2U relay) to update its MAC address, such as by indicating that it conflicts with the S-End UE's MAC address. In other words, the S-End UE's MAC address (e.g., as determined at 3.) may be treated with a higher precedence over the U2U relay MAC address(es).

At 8c., the first U2U relay may update its mapping table with the (e.g., new) MAC address as generated at 8b. by the first U2U relay, or received at 8d. from the S-End UE. The first U2U relay may send PC5-S response message to the second U2U relay which includes the (e.g., new) MAC address(es) of the first U2U relay or S-End UE (or both).

At 8f, the second U2U relay may validate the received MAC addresses (e.g., determine whether the MAC addresses provided at 8e. are in conflict or not) and proceed to the next hop (e.g., U2U_R3) to continue link establishment with the T-End UE.

In some embodiments, the PC5-S messages to request and/or respond with the (e.g., new) MAC addresses may be a new message (e.g., Get New MAC address request/response) or a modified DSM command/complete message with the indication as specified in 8a.

As shown as alternative B in FIG. 3, the second U2U relay may allocate a (e.g., new) MAC address for first U2U relay or the S-End UE at 9a., such as based on the conflict detection at 7.

At 9b., the first U2U relay may receive a PC5-S request message to receive the (e.g., new) MAC address from the second U2U relay. For example, the PC5-S request message may include an indication of the MAC address conflict (e.g., with the conflicting MAC address value) and a (e.g., newly) allocated MAC address for the first U2U relay or the S-End UE (or both). The first U2U relay may determine whether it is for the U2U_R1, the S-End UE, or for both, such as based on the indication in the message. If the MAC address of the first U2U relay is indicated as conflicting, the first U2U relay may update its MAC address (e.g., in its mapping table), and send a response back to the second U2U relay at 9c. If the MAC address of S-End UE is indicated as conflicting, the first U2U relay may proceed with steps 9c and 9d., otherwise the steps 9c. and 9d. may be skipped.

At 9c. and 9d., if the first U2U relay determines the indication of MAC address conflict is for the S-End UE, the first U2U relay may send a PC5-S request message to provide the (e.g., newly) allocated MAC address to the S-End UE, which sets the (e.g., new) address in its mapping table and responds back with an acknowledgement to the first U2U relay.

At 9c., the first U2U relay may update its mapping table with the (e.g., newly) allocated MAC address for the first U2U relay and/or for the S-End UE and may send back an acknowledgement to the second U2U relay. The second U2U relay may proceed to the next hop (e.g., U2U_R3) to continue link establishment with the T-End UE.

In some embodiments, the PC5-S messages to request/respond to the (e.g., newly) allocated MAC addresses may be a new message type (e.g., Set New MAC address request/response), or a modified DSM command/complete message with the indication as specified in 9b.

As shown as alternative C in FIG. 3, the second U2U relay may allocate a (e.g., new) MAC address for the first U2U relay or the S-End UE (or both) at 10a., such as based on the conflict detection at 7.

At 10b., the second U2U relay may use the (e.g., newly) allocated MAC address to update its mapping table and use the newly allocated MAC address in the following hops to establish the PC5 link with the T-End UE.

At 10c., the second U2U relay may receive a Direct Communication Accept (DCA) message from a third U2U relay (e.g., U2U_R3) indicating successful multi-hop PC5 link establishment with the T-End UE. Upon reception of the DCA message, the second U2U relay may send a DCA message to the first U2U relay. The DCA message may include the (e.g., newly) allocated MAC address (as allocated at 10a.) and may include an indication of a MAC address conflict to inform that the first U2U relay or the S-End UE (or both) has a conflicting MAC address(es).

At 10d., the first U2U relay may update its mapping table with the (e.g., new) MAC address(es). The first U2U relay may send the (e.g., new) MAC address(es) to the S-End UE.

As shown as alternative D in FIG. 3, the second U2U relay may send a DC Reject message to the U2U_R1 with a cause of “MAC address not unique” at 11a. The DC Reject message may indicate the MAC address and/or the UE ID whose MAC address is in conflict (e.g., not unique, such as the S-End UE or the first U2U relay, or both).

At 11b., upon reception of the DC Reject message from the second U2U relay, the first U2U relay may send a DC Reject message to the S-End UE with a cause “MAC address not unique” and indicate the MAC address and/or the UE ID whose MAC address is not unique (e.g., S-End UE).

For example, the S-End UE or the first U2U relay, upon reception of the DC Reject message, may update the MAC address(es) and use the (e.g., new) MAC address(es) for any future PC5 link establishment requests.

At 12., for any following hops, steps 4.-7 and any of alternative A, B, C or D may be repeated (e.g. for the next hop between U2U_R2 and U2U_R3), such as by replacing {U2U_R1 and U2U_R2} with {U2U_R2 and U2U_R3}.

### MAC Address Conflict Resolution During Connection Establishment Accept

In certain representative embodiments, a MAC address conflict may be detected and resolved when connection establishment is accepted by a T-end UE via multi-hop U2U relay. For example, MAC address conflict may be detected by one of the intermediate U2U relays after the link has been established.

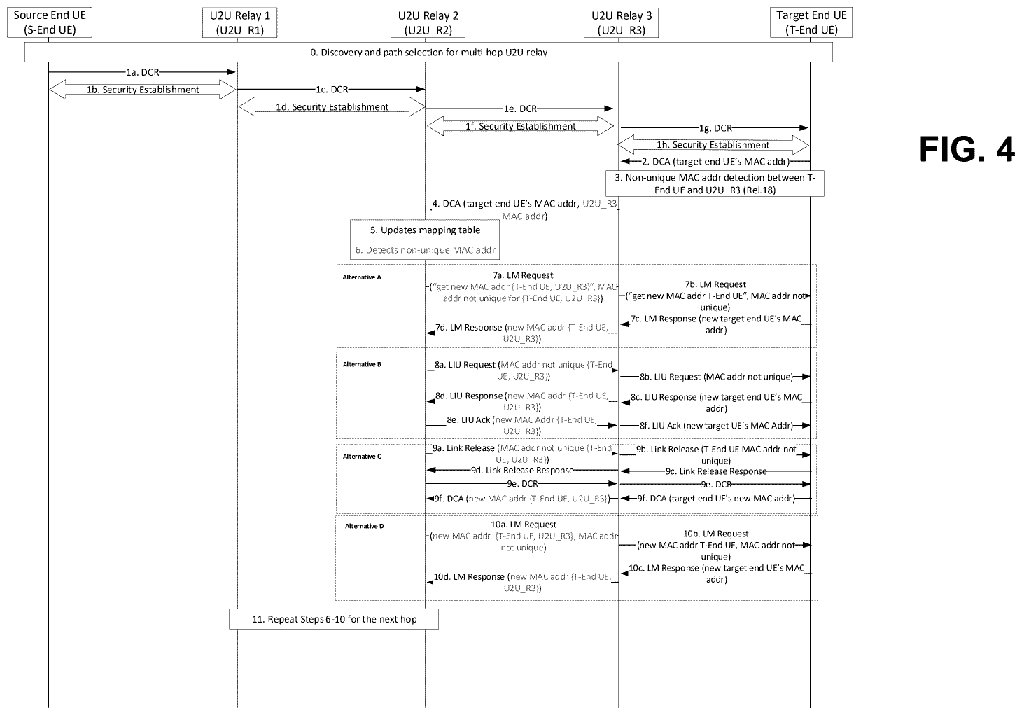

FIG. 4 a procedural diagram illustrating various examples of MAC address conflict resolution during connection establishment acceptance, according to one or more embodiments of the present disclosure.

In certain representative embodiments, such as in FIG. 4, it may be assumed that all the UEs involved in the E2E link establishment are capable of multi-hop U2U relay communication. It may be assumed that all the UEs have successfully registered, received confirmation and provisioning from the network. It may be assumed that the S-End UE and the T-End UE have discovered each other via multiple U2U-Relay(s) at 0. The S-End UE may initiate the multi-hop link establishment procedure by sending a direct communication request (DCR) message at 1a. to the nearest U2U relay UE (e.g., U2U_R1) for Ethernet traffic, which is received by a T-End UE via multi-hop links over 2 or more U2U relays (e.g., U2U-R2 and U2U-R3) via DCR messages at 1c., 1e. and 1g. MAC addresses of the S-End UE and the U2U relay(s) are sent (e.g., per-hop) in a Direct Security Mode (DSM) complete message during the security establishment at 1b., 1d., 1f. and 1h.

At 2., upon reception of a DSM complete message from a third U2U relay (e.g., U2U_R3), the T-End UE may accept or reject the PC5 multi-hop link establishment request from the S-End UE (e.g., step 1). If the T-End UE accepts the request, then the T-End UE may send a DCA message to the third U2U relay, which includes the T-End UE's MAC address and the S-End UE's MAC address.

At 3., the third U2U relay, upon reception of the DCA message from the T-End UE, may perform MAC address conflict (e.g., non-uniqueness) check. If the MAC address is detected to be non-unique at the third U2U relay, then the third U2U relay may follow the procedure specified in Rel. 18 (e.g., 3GPP TS 24.554) to initiate the link release procedure or may request a new MAC address from the T-End UE.

At 4., if the third U2U relay does not determine a MAC address conflict for the T-End UE's MAC address then third U2U relay may update its mapping table to include the T-End UE's MAC address and send another DCA message to a second U2U relay (e.g., U2U_R2). The DCA message may include the MAC addresses of the S-End UE, the T-End UE, and the third U2U relay.

At 5. and 6., the second U2U relay receives the DCA message, which includes the MAC addresses of the S-End UE, the T-End UE, and the third U2U relay (e.g., {S-End UE, T-End UE, U2U_R3}). The second U2U relay may update (or commit) the mapping table to include the T-End UE's MAC address. the second U2U relay may determine with there is a MAC address conflict with respect to (e.g., each) of the MAC addresses (e.g., to ensure the uniqueness of the MAC addresses), such that no two MAC addresses saved at the second U2U relay are the same. If the second U2U relay detects that a MAC address received from the T-End UE or the third U2U relay is conflicting (e.g., there is a conflict with the MAC address of another end UE or relay UE), then the following solutions are considered to handle the conflict. The second U2U relay may perform MAC address resolution of the conflicting MAC address(es), such as by using any of the following example procedures (e.g., Alternative A, B, C or D in FIG. 4).

As shown in alternative A in FIG. 4, at 7a., the second U2U relay may block traffic to from this PC5 link and send a Link Modification Request message to the third U2U relay with an operation code (e.g., “get new MAC address”), a cause code, (e.g., “MAC address not unique”) and/or an indication to indicate whether the conflict is detected for the third U2U relay's MAC address and/or the T-End UE's MAC address.

At 7b. and 7c., the third U2U relay may refer to the cause and indication to determine whether a conflict is detected for the third U2U relay's MAC address and/or the T-End UE's MAC address. If a conflict is detected for the T-End UE, the third U2U relay may block the traffic to/from this PC5 link that uses the conflicting MAC address. The third U2U relay may send a Link Modification Request message to the T-End UE with an operation code (e.g., “get new MAC address”) and/or a cause code (e.g., “MAC address not unique”). The T-End UE may send a Link Modification Response message including a (e.g., new) MAC address to the third U2U relay.

At 7d, if the conflict is detected for the third U2U relay's MAC address, then the third U2U relay may send a Link Modification Response including a (e.g., new) MAC address for the third U2U relay and updates the mapping table with the updated MAC address. At 7d., the third U2U relay may provide the second U2U relay with the updated MAC address of the T-End UE as received at 7c.

As shown in alternative B in FIG. 4, at 8a, the second U2U relay may take the detection of a MAC address conflict as a trigger for a Link Identifier Update (LIU) procedure. The second U2U relay may send a LIU Request message to the third U2U relay which includes an indication as to whether the conflict is detected for the third U2U relay's MAC address and/or the T-End UE's MAC address. This message may include a suggested MAC address(es) for the U2U_R3 or T-End UE (or both) and may include the S-End UE's MAC address.

At 8b., the third U2U relay may check the indication to determine whether the MAC address conflict is detected for the third U2U relay's MAC address and/or the T-End UE's MAC address. If a conflict is detected for the T-End UE, then the third U2U relay may send a LIU Request message to the T-End UE including an indication to indicate that the conflict is detected for the T-End UE's MAC address at 8b. At 8c., the T-End UE may send a LIU Response message including a (e.g., new) MAC address. At 8d., the third U2U relay may send a LIU Response message to the second U2U relay. For example, the LIU Response message may include (e.g., new) MAC address(es) for the third U2U relay or the T-End UE (or both). At 8c., the second U2U relay may send a LIU acknowledgment to the third U2U relay.

If the conflict is detected for (e.g., only) the third U2U relay's MAC address, then the third U2U relay may send a LIU response message including a (e.g., new) MAC address and update its mapping table with the (e.g., new) MAC address at 8d. The new MAC address may be selected from a list of suggested MAC addresses, such as provided at 8a. At 8f., the third U2U relay may send a LIU acknowledgment to the T-End UE which includes the T-End UE's (e.g., new MAC address).

As shown in alternative C in FIG. 3, at 9a., the second U2U relay may send a Link Release Request message to the third U2U relay including a cause code (e.g., “MAC address not unique”) and an indication to indicate whether the conflict is detected for the third U2U relay's MAC address or the T-End UE's MAC address (or both). The Link Release Request message may include a suggested MAC address (cs) for the third U2U relay or the T-End UE (or both).

At 9b, the third U2U relay may check the indication to determine whether conflict is detected for the third U2U relay's MAC address or the T-End UE's MAC address. If the conflict is detected for the T-End UE, then the third U2U relay may send a Link Release Request message to the T-End UE including an indication to indicate that the conflict is detected for the T-End UE's MAC address. At 9c., the T-End UE may send a Link Release Response message.

At 9d., if the conflict is detected for the third U2U relay's MAC address, then the third U2U relay may send the Link Release Response message to the second U2U relay.

At 9e, the second U2U relay may send another DCR message to the T-End UE via the third U2U relay. For example, the DCR messages may include a (e.g., new) MAC address(es) therein. At 9f., the T-End UE may send a DCA message via the third U2U relay. For example, the DCA messages may include the MAC address(es) from 9c.

Alternative D in FIG. 3 includes similar elements as Alternative A in FIG. 3 where a Link Modification Request and Link Modification Response messages are used. In Alternative D, the second U2U relay may allocate a (e.g., new) MAC address (e.g., instead of asking for a new MAC address). For example, at 10a., the second U2U relay may send an allocated MAC address(es), or a list of suggested MAC addresses, to the third U2U relay after a MAC address conflict is detected for the third U2U relay's MAC address or the T-End UE's MAC address. The Link Modification Request message at 10b may provide the same or similar to the T-End UE. For example, the T-End UE or third U2U relay may then pick from the suggested MAC addresses as their (e.g., new) MAC address(es) and confirm the same in the Link Modification response messages at 10c and 10d.

At 11., for any following hops, steps 4.-6. could be repeated and (e.g., then) any of alternative A, B, C or D may be repeated (e.g., for the next hop between U2U_R2 and U2U_R1), such as by replacing {U2U_R3 and U2U_R2} with {U2U_R2 and U2U_R1}.

MAC Address Conflict Resolution when a Direct Link Between a Pair of UEs is Reused for Multi-Hop U2U Relay Communication

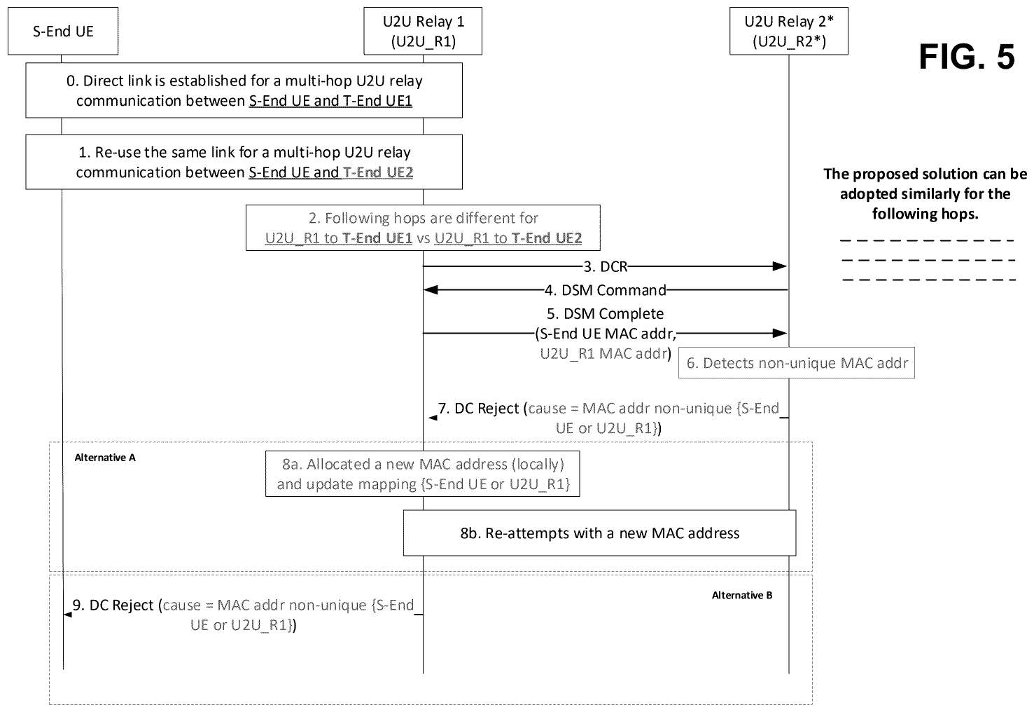

FIG. 5 a procedural diagram illustrating various examples of MAC address conflict resolution when a direct link is reused, according to one or more embodiments of the present disclosure.

In certain representative embodiments, such as in, FIG. 5, it may be assumed that the E2E communication link is already established between a S-End UE1 and a T-End UE1 using multi-hop U2U relay communication. In some multi-hop U2U relay implementations, the S-End UE1 may try to establish another E2E communication link with a different T-End UE (e.g., T-End UE2) by reusing a portion of the already established link, such where one or more hops are common to both links (e.g., the first hop is common for both E2E links). If a MAC address conflict is detected in such scenarios, MAC address resolution procedures may be performed.

At 0., in FIG. 5, an E2E communication link may (e.g., already) be established between the S-End UE and the T-End UE1, using multi-hop U2U relay communication.

At 1., the S-End UE1 may attempt to establish another E2E communication link with a different T-End UE, such as T-End UE2, where the S-End UE reuses the already established direct link between S-End UE and a first U2U relay (e.g., U2U_R1) on the first hop. At 2., the first U2U relay may determine the following hops in the two E2E links may not necessarily be the same, or in other words the multi-hop link between the first U2U_relay and the T-End UE1 may be different from the multi-hop link between the first U2U_relay to the T-End UE2.

At 3., the first U2U relay may send a DCR message to a second U2U relay (e.g., U2U_R2*). At 4., the second U2U relay may sed a DSM Command message to the first U2U relay. At 5., the first U2U relay may send the MAC address of the S-End UE and the MAC address of the first U2U relay to the second U2U relay, such as in a DSM Complete message.

At 6., the second U2U relay may create or update the mapping table to include the MAC addresses and the user information of the S-End UE1, the first U2U relay, and itself (e.g., U2U_R2*). For example, the second U2U relay may the MAC addresses for conflicts (e.g., to ensure the uniqueness of the MAC addresses, such that no two MAC addresses saved at the second U2U relay are the same). For example, the second U2U relay may detect that the MAC address received from the S-End UE or U2U_R1 (or both) is in conflict (e.g., not unique) with the MAC address of another end UE or relay UE.

At 7., the second U2U relay may send a DC Reject message to the first U2U relay. For example, the DC Reject message may include a cause (e.g., “MAC address not unique”) and indicate the MAC address which is in conflict (e.g., the MAC address of the S-End UE or first U2U relay).

In FIG. 5, the DC reject message is used at 7. as an example. In some representative embodiments, the DC reject message sent by the second U2U relay upon detection of a conflict may use another message as described elsewhere herein.

In FIG. 5, at the first hop, where the link is already in use for another E2E link and if a conflict is detected on the second link, then the first U2U relay may handle the MAC address conflict resolution.

In certain representative embodiments, the first U2U relay may handle MAC address conflict when the direct link between a pair of UEs (e.g., the S-End UE and U2U_R1) is used for multiple E2E links, such as by using any of the following example procedures (e.g., Alternative A or B in FIG. 5).

As shown as alternative A in FIG. 5, the first relay U2U (e.g., U2U_R1) may refer to the “indication” or the “cause code” about the MAC address conflict to determine for which UE the conflict (e.g., non-uniqueness) is identified at 8a (e.g., U2U_R1 or S-End UE).

For example, if the first U2U relay's MAC address is in conflict then the first U2U relay may update its MAC address and update its mapping table.

For example, if the S-End UE's MAC address is in conflict then the first U2U relay may (e.g., locally) update the S-End UE's MAC address (e.g., assign or allocate a new MAC address). The first U2U relay may update the mapping table for the link where the conflict is detected (e.g., the E2E multi-hop link between the S-End UE and the T-End UE2). In some embodiments, it may be assumed that the first U2U relay may maintain a separate mapping table per E2E link. The first U2U relay may update the mapping table such that the MAC address received from the S-End UE is known only to the first U2U relay, and a dummy or new MAC address of the S-End UE (e.g., which is assigned by the first U2U relay) may be used in the following hops. The first U2U relay may keep a record of the mapping between the actual S-End UE MAC address and the dummy or new MAC address of the S-End UE.

In the approach of alternative A in FIG. 5, the change of the MAC address (e.g., of the S-End UE) may be transparent to the S-End UE. Multiple E2E links may reuse the direct link between the S-End UE and second U2U relay. A change of the MAC address of the S-End UE may impact (e.g., only) the link that detects the MAC address conflict. For example, in FIG. 5, the MAC address conflict is handled by the first U2U relay (e.g., U2U_R1).

Table 1 below is a mapping table that depicts how the mapping table may look at the U2U_R1 for the given example before and after the MAC address conflict is detected.

TABLE 1

| Source | U2U_R1 | | Target |
|---|---|---|---|
| End UE | Ingress | Egress | End UE |

Before a MAC address conflict is detected

| | | | | |
|---|---|---|---|---|
| E2E link between | MAC S-End | MAC S-End | MAC S-End | MAC T-End |
| S-End UE and | UE | UE | UE | UE1 |
| T-End UE1 | | | MAC | |
| | | | U2U_R1 | |
| E2E link between | MAC S-End | MAC S-End | MAC S-End | |
| S-End UE and | UE | UE | UE | |
| T-End UE2 | | | MAC | |
| | | | U2U_R1 | |

After a MAC address conflict is detected by U2U_R2* for MAC of S-End UE
on the second link, and a new MAC address is allocated locally by U2U_R1

| | | | | |
|---|---|---|---|---|
| E2E link between | MAC S-End | MAC S-End | MAC S-End | MAC T-End |
| S-End UE and | UE | UE | UE | UE1 |
| T-End UE1 | | | MAC | |
| | | | U2U_R1 | |
| E2E link between | MAC S-End | MAC S-End | New MAC | |
| S-End UE and | UE | UE | S-End UE | |
| T-End UE2 | | | MAC | |
| | | | U2U_R1 | |

At 8b., after the MAC address is updated, the first U2U relay may re-try to establish the connection by returning to 3. in FIG. 5 (e.g., send another DCR message).

As shown as alternative B in FIG. 5, following the reception of the DC Reject message from the second U2U relay at 7., the first U2U relay may send a DC Reject message to the S-End UE with a cause (e.g., “MAC address not unique”) and indicate the MAC address is in conflict (e.g., non unique) for the S-End UE at 9.

For example, the S-End UE upon reception of the DC Reject message may update its MAC address and use the (e.g., new) MAC address for future PC5 link establishment requests (e.g., via the same or a different route).

The example shown in FIG. 5 may be adopted for the following hops, such as by replacing the S-End UE, U2U_R1, and U2U_R2* with the respective UEs in the following hops. The principles of MAC address resolution remain the same but with other UEs associated with the following hops.

### Avoiding Recurring MAC Address Conflicts

In certain representative embodiments, a MAC address conflict may be detected as described herein. For example, based on the detection of a conflict, a new or updated MAC address may be requested, allocated and/or generated by a UE (e.g., any of U2U_R3, U2U_R2, U2U_R1, S-End UE, or T-End UE). To ensure that a (e.g., new) MAC address doesn't conflict with another UE again, the detecting UE may use or provide additional information to assist with the allocation and/or generation of the (e.g., new) MAC address. For example, assistance information may include a list of least significant bits (LSBs) for (e.g., each) existing MAC address saved in the mapping table (e.g., of the detecting UE), or a portion of (e.g., each) existing MAC address saved in the mapping table (e.g., of the detecting UE). For example, the UE allocating and/or generating a new MAC address may use the list of LSBs or the portion of MAC addresses as an input when generating a (e.g., new) MAC addresses to avoid further conflicts.

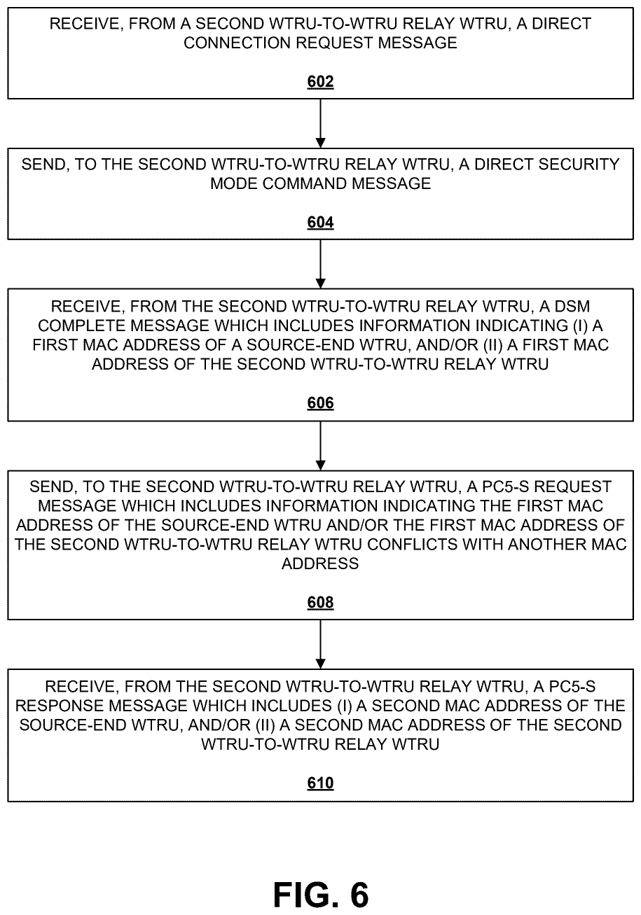

FIG. 6 a procedural diagram illustrating an example of MAC address conflict resolution during connection establishment requesting, according to one or more embodiments of the present disclosure. The procedure in FIG. 6 may be performed by a first WTRU-to-WTRU relay (e.g., a first relay WTRU). At 602, the first WTRU-to-WTRU relay may receive, from a second WTRU-to-WTRU relay WTRU, a direct connection request (DCR) message. At 604, the first WTRU-to-WTRU relay may send, to the second WTRU-to-WTRU relay WTRU, a direct security mode (DSM) command message. At 606, the first WTRU-to-WTRU relay may receive, from the second WTRU-to-WTRU relay WTRU, a DSM complete message which includes information indicating (i) a first MAC address of a source-end WTRU, and/or (ii) a first MAC address of the second WTRU-to-WTRU relay WTRU. At 608, the first WTRU-to-WTRU relay may send, to the second WTRU-to-WTRU relay WTRU, a PC5-S request message which includes information indicating the first MAC address of the source-end WTRU and/or the first MAC address of the second WTRU-to-WTRU relay WTRU conflicts with another MAC address. At 610, the first WTRU-to-WTRU relay may receive, from the second WTRU-to-WTRU relay WTRU, a PC5-S response message which includes (i) a second (e.g., new or updated) MAC address of the source-end WTRU, and/or (ii) a second (e.g., new or updated) MAC address of the second WTRU-to-WTRU relay WTRU.

In certain representative embodiments, the first WTRU-to-WTRU relay may determine the second MAC address of the source-end WTRU and the second MAC address of the second WTRU-to-WTRU relay WTRU do not conflict with any other MAC address stored in a mapping table at the first WTRU-to-WTRU relay WTRU.

In certain representative embodiments, the PC5-S request message may include information indicating the first MAC address of the source-end WTRU conflicts with the other MAC address and an identifier of the source-end WTRU.

In certain representative embodiments, the PC5-S request message may include information indicating the first MAC address of the second WTRU-to-WTRU relay WTRU conflicts with the other MAC address and an identifier of the second WTRU-to-WTRU relay WTRU.

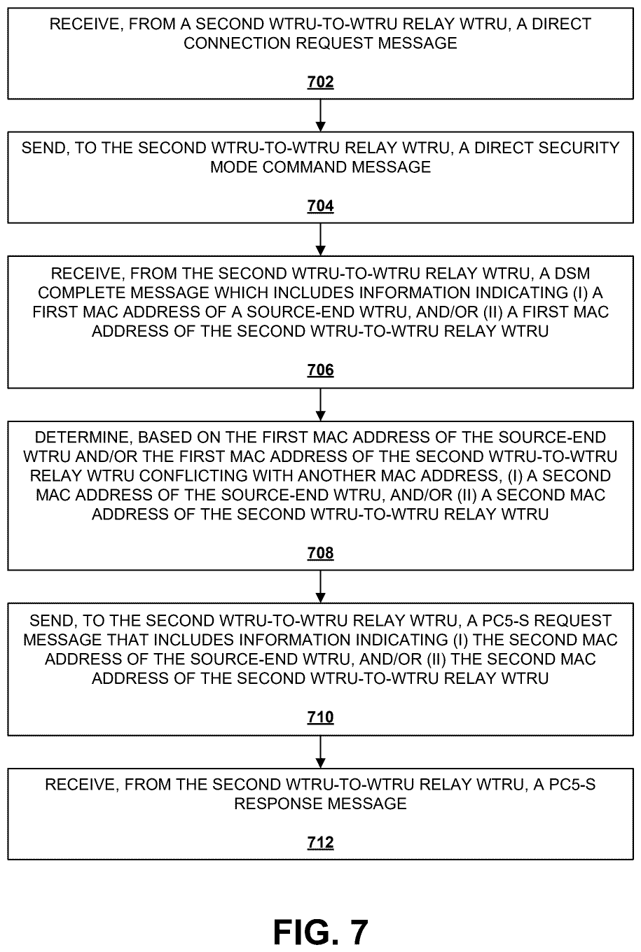

FIG. 7 a procedural diagram illustrating an example of MAC address conflict resolution during connection establishment requesting, according to one or more embodiments of the present disclosure. The procedure in FIG. 7 may be performed by a first WTRU-to-WTRU relay (e.g., a first relay WTRU). At 702, the first WTRU-to-WTRU relay may receive, from a second WTRU-to-WTRU relay WTRU, a direct connection request (DCR) message. At 704, the first WTRU-to-WTRU relay may send, to the second WTRU-to-WTRU relay WTRU, a direct security mode (DSM) command message. At 706, the first WTRU-to-WTRU relay may receive, from the second WTRU-to-WTRU relay WTRU, a DSM complete message which includes information indicating (i) a first MAC address of a source-end WTRU, and/or (ii) a first MAC address of the second WTRU-to-WTRU relay WTRU. At 708, the first WTRU-to-WTRU relay may determine, based on the first MAC address of the source-end WTRU and/or the first MAC address of the second WTRU-to-WTRU relay WTRU conflicting with another MAC address, (i) a second MAC address of the source-end WTRU, and/or (ii) a second MAC address of the second WTRU-to-WTRU relay WTRU. At 710, the first WTRU-to-WTRU relay may send, to the second WTRU-to-WTRU relay WTRU, a PC5-S request message that includes information indicating (i) the second MAC address of the source-end WTRU, and/or (ii) the second MAC address of the second WTRU-to-WTRU relay WTRU. At 712, the first WTRU-to-WTRU relay may receive, from the second WTRU-to-WTRU relay WTRU, a PC5-S response message.

In certain representative embodiments, the PC5-S request message may be a set MAC address request or a DSM command message.

In certain representative embodiments, the PC5-S response message may be a set MAC address response or a DSM complete message.

In certain representative embodiments, the first WTRU-to-WTRU relay may send, to a third WTRU-to-WTRU relay WTRU (e.g., next hop), a DCR message.

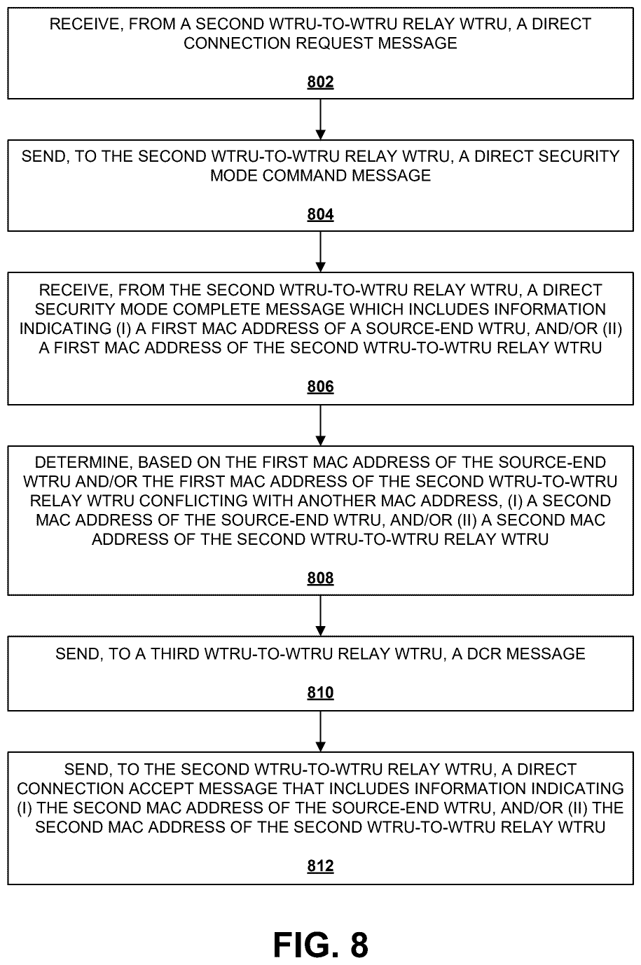

FIG. 8 a procedural diagram illustrating another example of MAC address conflict resolution during connection establishment requesting, according to one or more embodiments of the present disclosure. The procedure in FIG. 8 may be performed by a first WTRU-to-WTRU relay (e.g., a first relay WTRU). At 802, the first WTRU-to-WTRU relay may receive, from a second WTRU-to-WTRU relay WTRU, a direct connection request (DCR) message. At 804, the first WTRU-to-WTRU relay may send, to the second WTRU-to-WTRU relay WTRU, a direct security mode (DSM) command message. At 806, the first WTRU-to-WTRU relay may receive, from the second WTRU-to-WTRU relay WTRU, a DSM complete message which includes information indicating (i) a first Medium MAC address of a source-end WTRU, and/or (ii) a first MAC address of the second WTRU-to-WTRU relay WTRU. At 808, the first WTRU-to-WTRU relay may determine, based on the first MAC address of the source-end WTRU and/or the first MAC address of the second WTRU-to-WTRU relay WTRU conflicting with another MAC address, (i) a second (e.g., new or updated) MAC address of the source-end WTRU, and/or (ii) a second (e.g., new or updated) MAC address of the second WTRU-to-WTRU relay WTRU. At 810, the first WTRU-to-WTRU relay may send, to a third WTRU-to-WTRU relay WTRU (e.g., next hop), a DCR message. At 812, the first WTRU-to-WTRU relay may send, to the second WTRU-to-WTRU relay WTRU, a direct connection accept (DCA) message that includes information indicating (i) the second MAC address of the source-end WTRU, and/or (ii) the second MAC address of the second WTRU-to-WTRU relay WTRU.

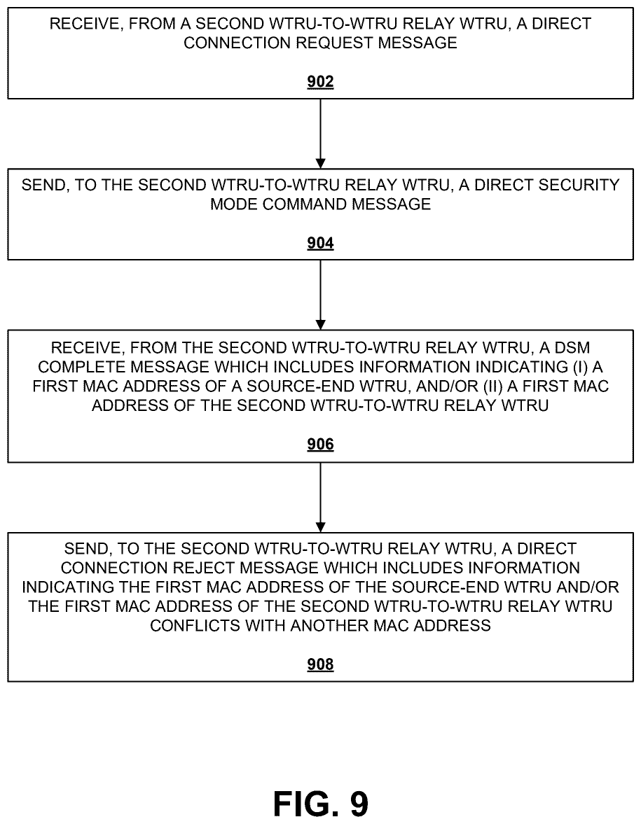

FIG. 9 a procedural diagram illustrating another example of MAC address conflict resolution during connection establishment requesting, according to one or more embodiments of the present disclosure. The procedure in FIG. 9 may be performed by a first WTRU-to-WTRU relay (e.g., a first relay WTRU). At 902, the first WTRU-to-WTRU relay may receive, from a second WTRU-to-WTRU relay WTRU, a direct connection request (DCR) message. At 904, the first WTRU-to-WTRU relay may send, to the second WTRU-to-WTRU relay WTRU, a direct security mode (DSM) command message. At 908, the first WTRU-to-WTRU relay may receive, from the second WTRU-to-WTRU relay WTRU, a DSM complete message which includes information indicating (i) a first MAC address of a source-end WTRU, and/or (ii) a first MAC address of the second WTRU-to-WTRU relay WTRU. At 910, the first WTRU-to-WTRU relay may send, to the second WTRU-to-WTRU relay WTRU, a direct connection reject message which includes information indicating the first MAC address of the source-end WTRU and/or the first MAC address of the second WTRU-to-WTRU relay WTRU conflicts with another MAC address.

In certain representative embodiments, the first WTRU-to-WTRU relay may determine the first MAC address of the source-end WTRU and/or the first MAC address of the second WTRU-to-WTRU relay WTRU conflicts with the other MAC address stored in a mapping table at the first WTRU-to-WTRU relay WTRU.

In certain representative embodiments, the DCR message may be associated with establishing a PC5 link between the source-end WTRU and a target-end WTRU via at least the first WTRU-to-WTRU relay WTRU and the second WTRU-to-WTRU relay WTRU.

In certain representative embodiments, the direct connection reject message may include information indicating the first MAC address of the source-end WTRU conflicts with the other MAC address and an identifier of the source-end WTRU.

In certain representative embodiments, the direct connection reject message may include information indicating the first MAC address of the second WTRU-to-WTRU relay WTRU conflicts with the other MAC address and an identifier of the second WTRU-to-WTRU relay WTRU.

In certain representative embodiments, the information indicating the first MAC address of the source-end WTRU and/or the first MAC address of the second WTRU-to-WTRU relay WTRU conflicts with another MAC address is, includes, or is associated with a cause code.

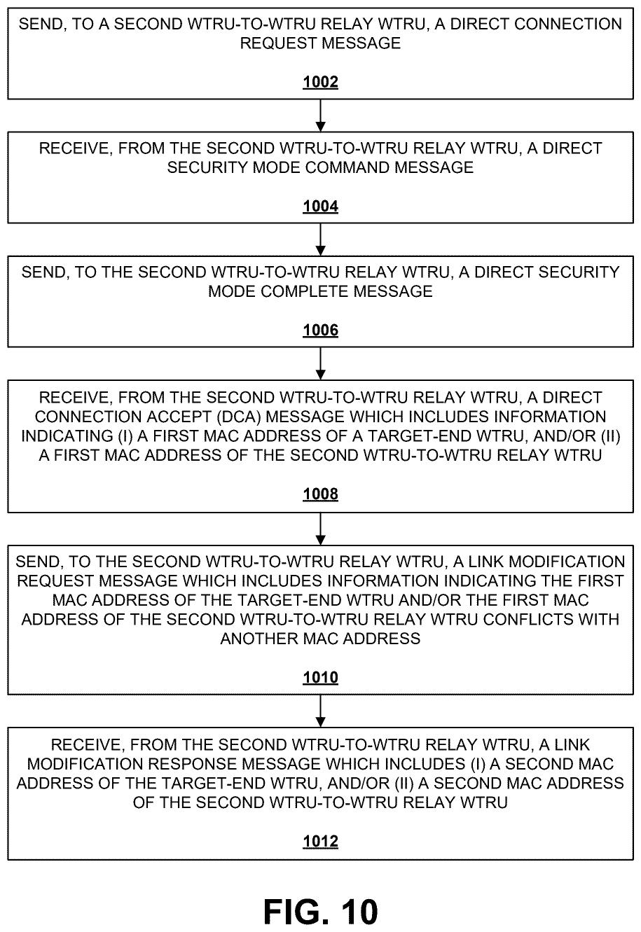

FIG. 10 a procedural diagram illustrating an example of MAC address conflict resolution during connection establishment acceptance, according to one or more embodiments of the present disclosure. The procedure in FIG. 10 may be performed by a first WTRU-to-WTRU relay (e.g., a first relay WTRU). At 1002, the first WTRU-to-WTRU relay may send, to a second WTRU-to-WTRU relay WTRU, a direct connection request (DCR) message. At 1004, the first WTRU-to-WTRU relay may receive, from the second WTRU-to-WTRU relay WTRU, a direct security mode (DSM) command message. At 1006, the first WTRU-to-WTRU relay may send, to the second WTRU-to-WTRU relay WTRU, a DSM complete message. At 1008, the first WTRU-to-WTRU relay may receive, from the second WTRU-to-WTRU relay WTRU, a direct connection accept (DCA) message which includes information indicating (i) a first MAC address of a target-end WTRU, and/or (ii) a first MAC address of the second WTRU-to-WTRU relay WTRU. At 1010, the first WTRU-to-WTRU relay may send, to the second WTRU-to-WTRU relay WTRU, a link modification request message which includes information indicating the first MAC address of the target-end WTRU and/or the first MAC address of the second WTRU-to-WTRU relay WTRU conflicts with another MAC address. At 1012, the first WTRU-to-WTRU relay may receive, from the second WTRU-to-WTRU relay WTRU, a link modification response message which includes (i) a second (e.g., new or updated) MAC address of the target-end WTRU, and/or (ii) a second (e.g., new or updated) MAC address of the second WTRU-to-WTRU relay WTRU.

In certain representative embodiments, the first WTRU-to-WTRU relay may trigger the link modification request message (e.g., to be sent) based on a determination that at least one of the first MAC address of the target-end WTRU and/or the first MAC address of the second WTRU-to-WTRU relay WTRU conflicts with another MAC address.

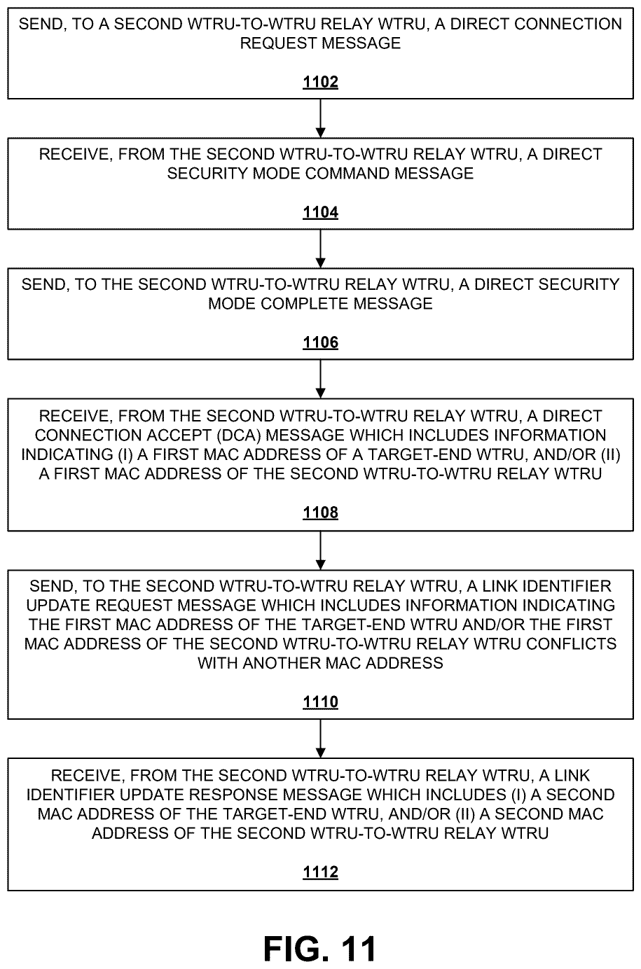

FIG. 11 a procedural diagram illustrating another example of MAC address conflict resolution during connection establishment acceptance, according to one or more embodiments of the present disclosure. The procedure in FIG. 11 may be performed by a first WTRU-to-WTRU relay (e.g., a first relay WTRU). At 1102, the first WTRU-to-WTRU relay may send, to a second WTRU-to-WTRU relay WTRU, a direct connection request (DCR) message. At 1104, the first WTRU-to-WTRU relay may receive, from the second WTRU-to-WTRU relay WTRU, a direct security mode (DSM) command message. At 1106, the first WTRU-to-WTRU relay may send, to the second WTRU-to-WTRU relay WTRU, a DSM complete message. At 1108, the first WTRU-to-WTRU relay may receive, from the second WTRU-to-WTRU relay WTRU, a direct connection accept (DCA) message which includes information indicating (i) a first MAC address of a target-end WTRU, and/or (ii) a first MAC address of the second WTRU-to-WTRU relay WTRU. At 1110, the first WTRU-to-WTRU relay may send, to the second WTRU-to-WTRU relay WTRU, a link identifier update request message which includes information indicating the first MAC address of the target-end WTRU and/or the first MAC address of the second WTRU-to-WTRU relay WTRU conflicts with another MAC address. At 1112, the first WTRU-to-WTRU relay may receive, from the second WTRU-to-WTRU relay WTRU, a link identifier update response message which includes (i) a second (e.g., new or updated) MAC address of the target-end WTRU, and/or (ii) a second (e.g., new or updated) MAC address of the second WTRU-to-WTRU relay WTRU.

In certain representative embodiments, the first WTRU-to-WTRU relay may trigger the link identifier update request message (e.g., to be sent) based on a determination that at least one of the first MAC address of the target-end WTRU and/or the first MAC address of the second WTRU-to-WTRU relay WTRU conflicts with another MAC address.

In certain representative embodiments, the first WTRU-to-WTRU relay may send, to the second WTRU-to-WTRU relay WTRU, an acknowledgement message, in response to the link identifier update response message, which includes information indicating (i) the second MAC address of the target-end WTRU, and/or (ii) the second MAC address of the second WTRU-to-WTRU relay WTRU.

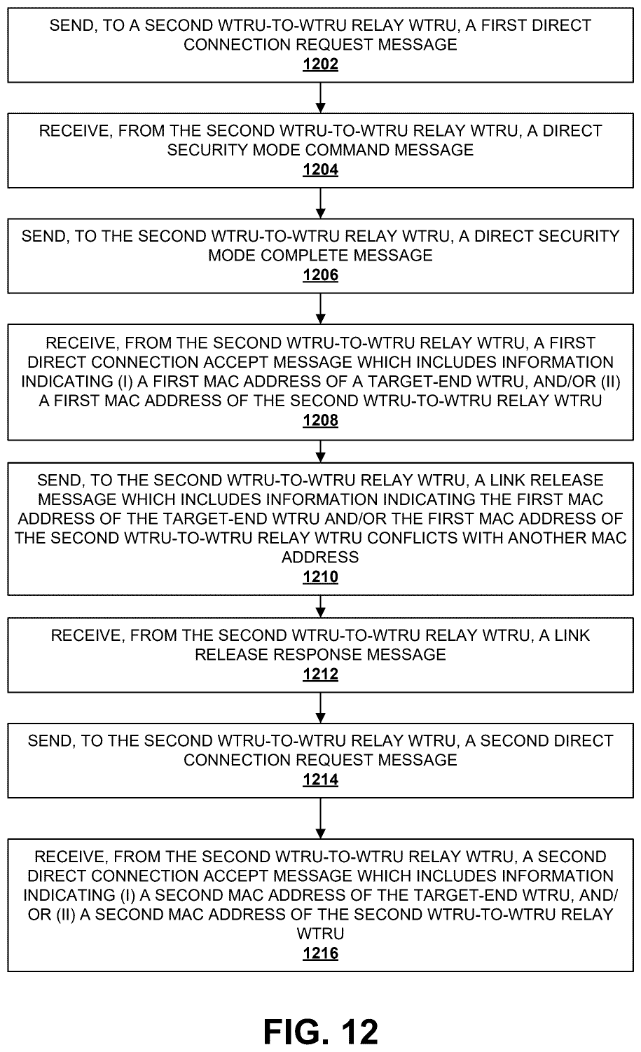

FIG. 12 a procedural diagram illustrating another example of MAC address conflict resolution during connection establishment acceptance, according to one or more embodiments of the present disclosure. The procedure in FIG. 12 may be performed by a first WTRU-to-WTRU relay (e.g., a first relay WTRU). At 1202, the first WTRU-to-WTRU relay may send, to a second WTRU-to-WTRU relay WTRU, a first direct connection request (DCR) message. At 1204, the first WTRU-to-WTRU relay may receive, from the second WTRU-to-WTRU relay WTRU, a direct security mode (DSM) command message. At 1206, the first WTRU-to-WTRU relay may send, to the second WTRU-to-WTRU relay WTRU, a DSM complete message. At 1208, the first WTRU-to-WTRU relay may receive, from the second WTRU-to-WTRU relay WTRU, a first direct connection accept (DCA) message which includes information indicating (i) a first MAC address of a target-end WTRU, and/or (ii) a first MAC address of the second WTRU-to-WTRU relay WTRU. At 1210, the first WTRU-to-WTRU relay may send, to the second WTRU-to-WTRU relay WTRU, a link release message which includes information indicating the first MAC address of the target-end WTRU and/or the first MAC address of the second WTRU-to-WTRU relay WTRU conflicts with another MAC address. At 1212, the first WTRU-to-WTRU relay may receive, from the second WTRU-to-WTRU relay WTRU, a link release response message. At 1214, the first WTRU-to-WTRU relay may send, to the second WTRU-to-WTRU relay WTRU, a second DCR message. At 1216, the first WTRU-to-WTRU relay may receive, from the second WTRU-to-WTRU relay WTRU, a second DCA message which includes information indicating (i) a second (e.g., new or updated) MAC address of the target-end WTRU, and/or (ii) a second (e.g., new or updated) MAC address of the second WTRU-to-WTRU relay WTRU.

In certain representative embodiments, the first WTRU-to-WTRU relay may trigger the link release message (e.g., to be sent) based on a determination that at least one of the first MAC address of the target-end WTRU and/or the first MAC address of the second WTRU-to-WTRU relay WTRU conflicts with another MAC address.

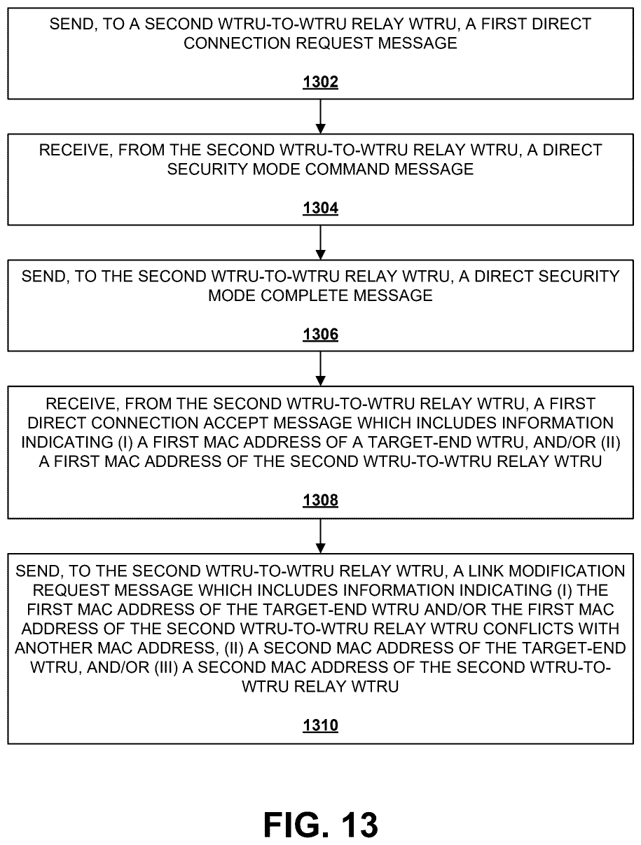

FIG. 13 a procedural diagram illustrating another example of MAC address conflict resolution during connection establishment acceptance, according to one or more embodiments of the present disclosure. The procedure in FIG. 13 may be performed by a first WTRU-to-WTRU relay (e.g., a first relay WTRU). At 1302, the first WTRU-to-WTRU relay may send, to a second WTRU-to-WTRU relay WTRU, a first direct connection request (DCR) message. At 1304, the first WTRU-to-WTRU relay may receive, from the second WTRU-to-WTRU relay WTRU, a direct security mode (DSM) command message. At 1306, the first WTRU-to-WTRU relay may send, to the second WTRU-to-WTRU relay WTRU, a DSM complete message. At 1308, the first WTRU-to-WTRU relay may receive, from the second WTRU-to-WTRU relay WTRU, a first direct connection accept (DCA) message which includes information indicating (i) a first MAC address of a target-end WTRU, and/or (ii) a first MAC address of the second WTRU-to-WTRU relay WTRU. At 1310, the first WTRU-to-WTRU relay may send, to the second WTRU-to-WTRU relay WTRU, a link modification request message which includes information indicating (i) the first MAC address of the target-end WTRU and/or the first MAC address of the second WTRU-to-WTRU relay WTRU conflicts with another MAC address, (ii) a second (e.g., new or updated) MAC address of the target-end WTRU, and/or (iii) a second (e.g., new or updated) MAC address of the second WTRU-to-WTRU relay WTRU.

In certain representative embodiments, the first WTRU-to-WTRU relay may trigger the link modification request message (e.g., to be sent) based on a determination that at least one of the first MAC address of the target-end WTRU and/or the first MAC address of the second WTRU-to-WTRU relay WTRU conflicts with another MAC address.

In certain representative embodiments, the first WTRU-to-WTRU relay may receive, from the second WTRU-to-WTRU relay WTRU, a link modification response message which includes information indicating (i) the second MAC address of the target-end WTRU, and/or (iii) the second MAC address of the second WTRU-to-WTRU relay WTRU.

In certain representative embodiments, the information indicating the first MAC address of the target-end WTRU and/or the first MAC address of the second WTRU-to-WTRU relay WTRU conflicts with another MAC address may be an operation code and/or a cause code.

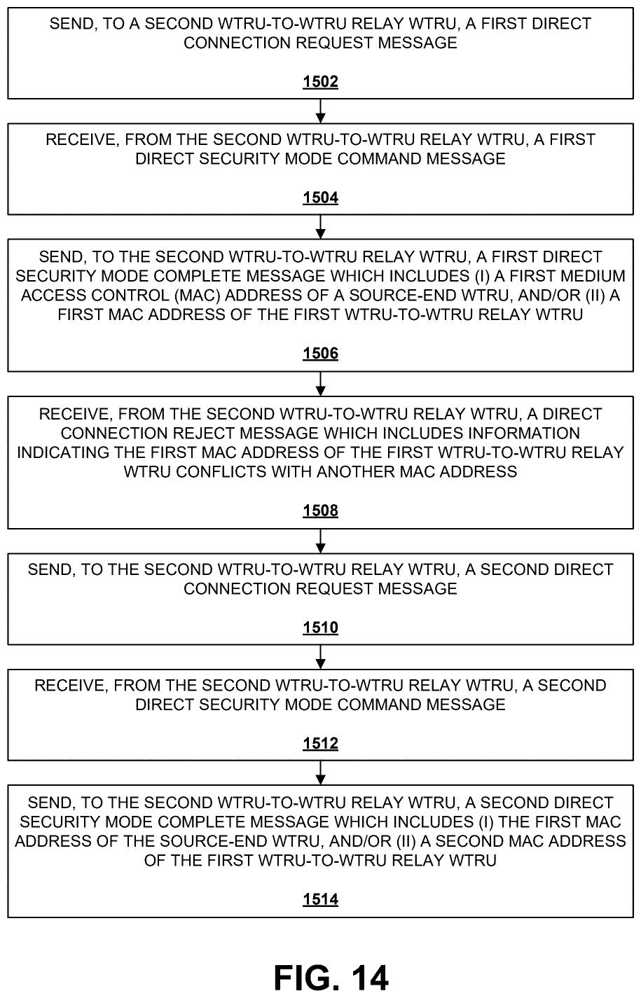

FIG. 14 a procedural diagram illustrating an example of MAC address conflict resolution when a direct link is reused, according to one or more embodiments of the present disclosure. The procedure in FIG. 14 may be performed by a first WTRU-to-WTRU relay (e.g., a first relay WTRU). At 1402, the first WTRU-to-WTRU relay may send, to a second WTRU-to-WTRU relay WTRU, a first direct connection request (DCR) message. At 1404, the first WTRU-to-WTRU relay may receive, from the second WTRU-to-WTRU relay WTRU, a first direct security mode (DSM) command message. At 1406, the first WTRU-to-WTRU relay may send, to the second WTRU-to-WTRU relay WTRU, a first DSM complete message which includes (i) a first MAC address of a source-end WTRU, and/or (ii) a first MAC address of the first WTRU-to-WTRU relay WTRU. At 1408, the first WTRU-to-WTRU relay may receive, from the second WTRU-to-WTRU relay WTRU, a direct connection reject message which includes information indicating the first MAC address of the first WTRU-to-WTRU relay WTRU conflicts with another MAC address. At 1410, the first WTRU-to-WTRU relay may send, to the second WTRU-to-WTRU relay WTRU, a second DCR message. At 1412, the first WTRU-to-WTRU relay may receive, from the second WTRU-to-WTRU relay WTRU, a second DSM command message. At 1414, the first WTRU-to-WTRU relay may send, to the second WTRU-to-WTRU relay WTRU, a second DSM complete message which includes (i) the first MAC address of the source-end WTRU, and/or (ii) a second (e.g., new or updated) MAC address of the first WTRU-to-WTRU relay WTRU.

In certain representative embodiments, the first WTRU-to-WTRU relay may determine the second MAC address of the first WTRU-to-WTRU relay WTRU in response to the direct connection reject message.

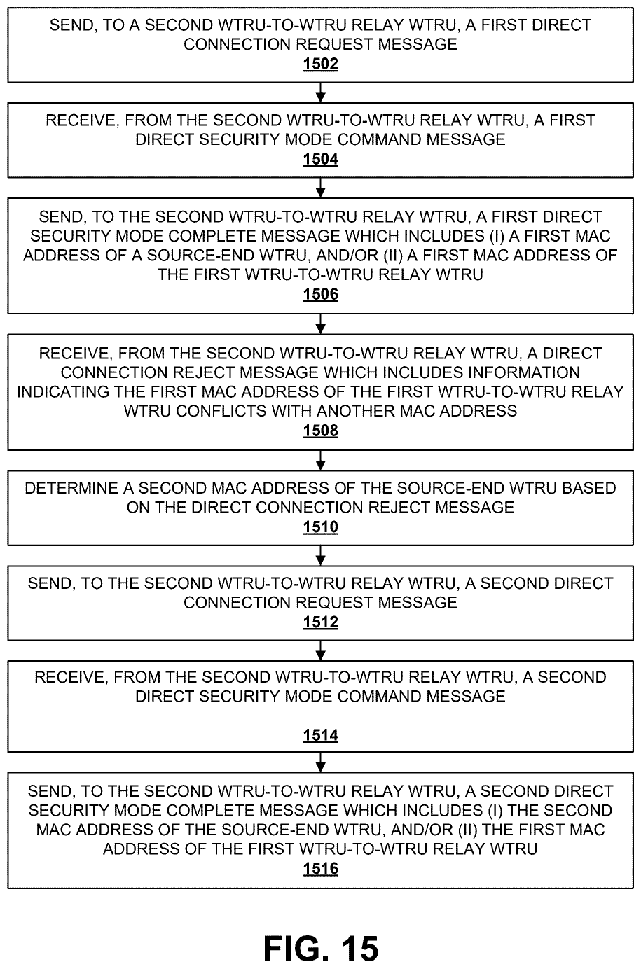

FIG. 15 a procedural diagram illustrating another example of MAC address conflict resolution when a direct link is reused, according to one or more embodiments of the present disclosure. The procedure in FIG. 15 may be performed by a first WTRU-to-WTRU relay (e.g., a first relay WTRU). At 1502, the first WTRU-to-WTRU relay may send, to a second WTRU-to-WTRU relay WTRU, a first direct connection request (DCR) message. At 1504, the first WTRU-to-WTRU relay may receive, from the second WTRU-to-WTRU relay WTRU, a first direct security mode (DSM) command message. At 1506, the first WTRU-to-WTRU relay may send, to the second WTRU-to-WTRU relay WTRU, a first DSM complete message which includes (i) a first MAC address of a source-end WTRU, and/or (ii) a first MAC address of the first WTRU-to-WTRU relay WTRU. At 1508, the first WTRU-to-WTRU relay may receive, from the second WTRU-to-WTRU relay WTRU, a direct connection reject message which includes information indicating the first MAC address of the first WTRU-to-WTRU relay WTRU conflicts with another MAC address. At 1510, the first WTRU-to-WTRU relay may determine a second (e.g., new or updated) MAC address of the source-end WTRU based on the direct connection reject message. At 1512, the first WTRU-to-WTRU relay may send, to the second WTRU-to-WTRU relay WTRU, a second DCR message. At 1514, the first WTRU-to-WTRU relay may receive, from the second WTRU-to-WTRU relay WTRU, a second DSM command message. At 1516, the first WTRU-to-WTRU relay may send, to the second WTRU-to-WTRU relay WTRU, a second DSM complete message which includes (i) the second MAC address of the source-end WTRU, and/or (ii) the first MAC address of the first WTRU-to-WTRU relay WTRU.

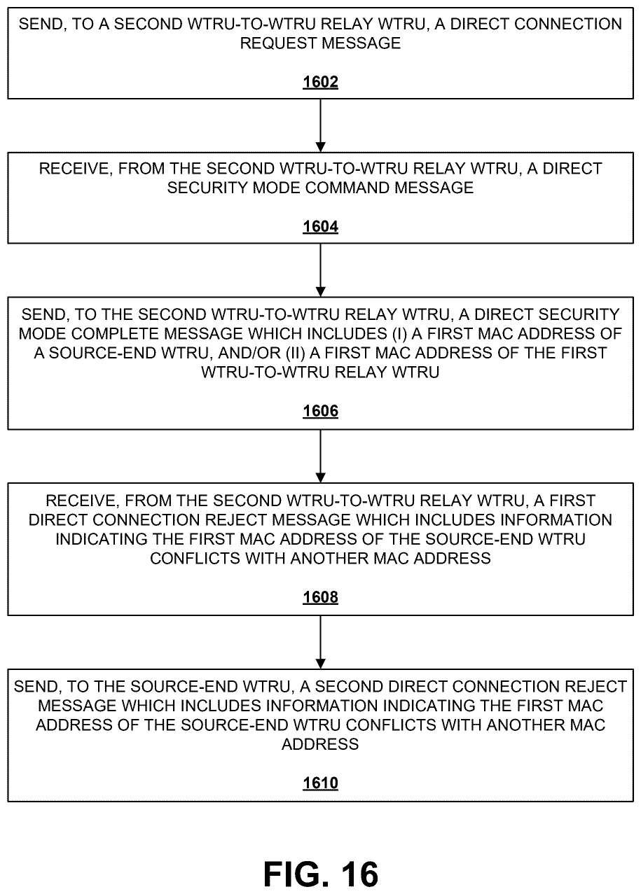

FIG. 16 a procedural diagram illustrating another example of MAC address conflict resolution when a direct link is reused, according to one or more embodiments of the present disclosure. The procedure in FIG. 16 may be performed by a first WTRU-to-WTRU relay (e.g., a first relay WTRU). At 1602, the first WTRU-to-WTRU relay may send, to a second WTRU-to-WTRU relay WTRU, a direct connection request (DCR) message. At 1604, the first WTRU-to-WTRU relay may receive, from the second WTRU-to-WTRU relay WTRU, a direct security mode (DSM) command message. At 1606, the first WTRU-to-WTRU relay may send, to the second WTRU-to-WTRU relay WTRU, a DSM complete message which includes (i) a first MAC address of a source-end WTRU, and/or (ii) a first MAC address of the first WTRU-to-WTRU relay WTRU. At 1608, the first WTRU-to-WTRU relay may receive, from the second WTRU-to-WTRU relay WTRU, a first direct connection reject message which includes information indicating the first MAC address of the source-end WTRU conflicts with another MAC address. At 1610, the first WTRU-to-WTRU relay may send, to the source-end WTRU, a second direct connection reject message which includes information indicating the first MAC address of the source-end WTRU conflicts with another MAC address.

In certain representative embodiments, the first WTRU-to-WTRU relay may establish a direct link between the source-end WTRU and a first target-end WTRU (e.g., before the DCR message is received at 1602). The DCR message (e.g., at 1602) may be associated with establishing a direct link between the source-end WTRU and a second target-end WTRU.

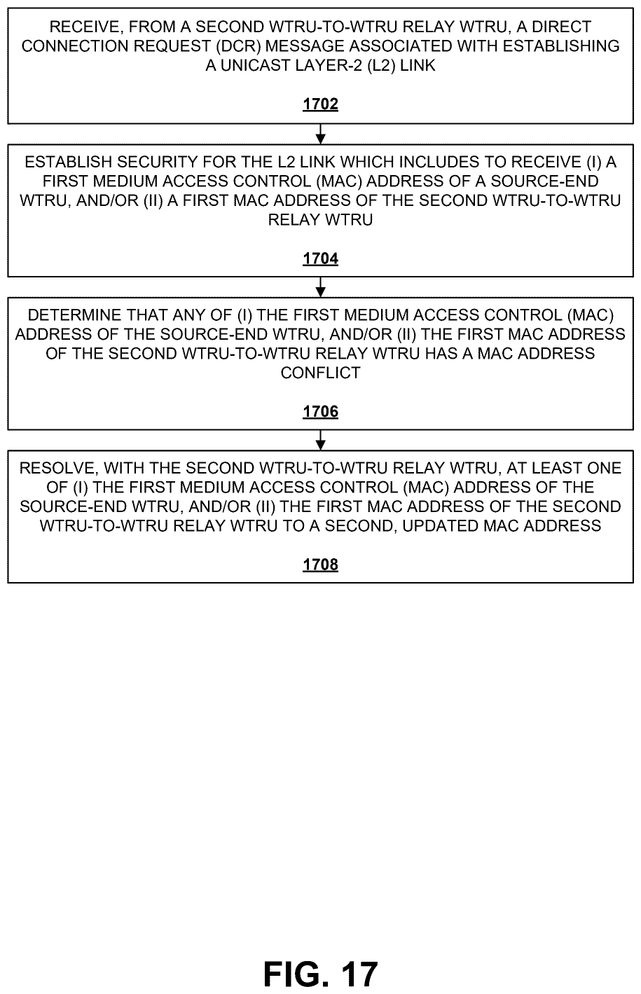

FIG. 17 a procedural diagram illustrating an example of MAC address conflict resolution, according to one or more embodiments of the present disclosure. The procedure in FIG. 17 may be performed by a first WTRU-to-WTRU relay (e.g., a first relay WTRU). At 1702, the first WTRU-to-WTRU relay may receive, from a second WTRU-to-WTRU relay WTRU, a direct connection request (DCR) message associated with establishing a unicast Layer-2 (L2) link. At 1704, the first WTRU-to-WTRU relay may establish security (e.g., authorization and/or key establishment) for the L2 link which includes to receive (i) a first Medium Access Control (MAC) address of a source-end WTRU, and/or (ii) a first MAC address of the second WTRU-to-WTRU relay WTRU. At 1706, the first WTRU-to-WTRU relay may determine that any of (i) the first Medium Access Control (MAC) address of the source-end WTRU, and/or (ii) the first MAC address of the second WTRU-to-WTRU relay WTRU has a MAC address conflict. At 1708, the first WTRU-to-WTRU relay may resolve, with the second WTRU-to-WTRU relay WTRU, at least one of (i) the first Medium Access Control (MAC) address of the source-end WTRU, and/or (ii) the first MAC address of the second WTRU-to-WTRU relay WTRU to a second, updated MAC address.

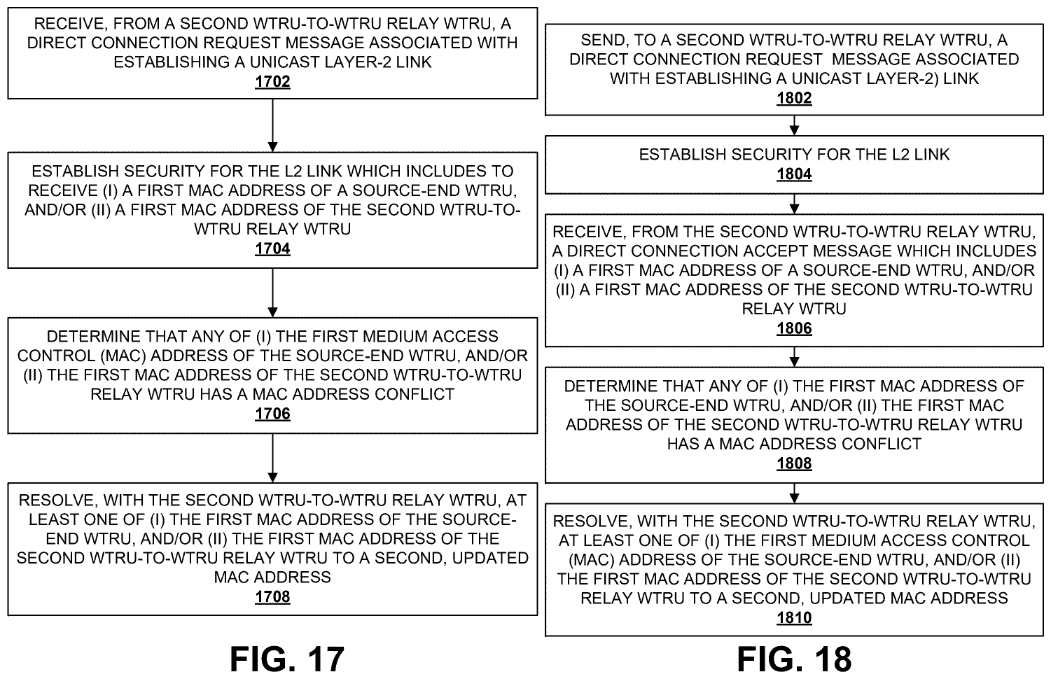

FIG. 18 a procedural diagram illustrating another example of MAC address conflict resolution, according to one or more embodiments of the present disclosure. The procedure in FIG. 18 may be performed by a first WTRU-to-WTRU relay (e.g., a first relay WTRU). At 1802, the first WTRU-to-WTRU relay may send, to a second WTRU-to-WTRU relay WTRU, a direct connection request (DCR) message associated with establishing a unicast Layer-2 (L2) link. At 1804, the first WTRU-to-WTRU relay may establish security (e.g., authorization and/or key establishment) for the L2 link. At 1806, the first WTRU-to-WTRU relay may receive, from the second WTRU-to-WTRU relay WTRU, a direct connection accept message which includes (i) a first Medium Access Control (MAC) address of a source-end WTRU, and/or (ii) a first MAC address of the second WTRU-to-WTRU relay WTRU. At 1808, the first WTRU-to-WTRU relay may determine that any of (i) the first Medium Access Control (MAC) address of the source-end WTRU, and/or (ii) the first MAC address of the second WTRU-to-WTRU relay WTRU has a MAC address conflict. At 1810, the first WTRU-to-WTRU relay may resolve, with the second WTRU-to-WTRU relay WTRU, at least one of (i) the first Medium Access Control (MAC) address of the source-end WTRU, and/or (ii) the first MAC address of the second WTRU-to-WTRU relay WTRU to a second, updated MAC address.

### REFERENCES

Each of the contents of the following references is incorporated by reference herein: (1) TS 23.304, Proximity based Services (ProSe) in the 5G System (5GS); Stage 2, v19.1.0 (Release 19); (2) 3GPP TR 23.700-03 v0.2.0 Study on system enhancement for Proximity based Services (ProSe) in the 5G System (5GS); Phase 3 (Release 19); (3) RFC 7181 The Optimized Link State Routing Protocol Version 2; (4) RFC 6130 Mobile Ad Hoc Network (MANET) Neighborhood Discovery Protocol (NHDP); and (5) TS 24.554 Proximity-services (ProSe) in 5G System (5GS) protocol aspects; Stage 3, V18.6.0, (Release 18).

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

1.-58. (canceled)

59. A first wireless transmit/receive unit-to-wireless transmit/receive unit (WTRU-to-WTRU) relay WTRU comprising:
a processor, memory, and a transceiver which are configured to:
receive, from a second WTRU-to-WTRU relay WTRU, a direct connection request (DCR) message,
send, to the second WTRU-to-WTRU relay WTRU, a direct security mode (DSM) command message,
receive, from the second WTRU-to-WTRU relay WTRU, a DSM complete message which includes information indicating (i) a first Medium Access Control (MAC) address of a source-end WTRU, and/or (ii) a first MAC address of the second WTRU-to-WTRU relay WTRU,
send, to the second WTRU-to-WTRU relay WTRU, a PC5-S request message which includes information indicating the first MAC address of the source-end WTRU and/or the first MAC address of the second WTRU-to-WTRU relay WTRU conflicts with another MAC address, and
receive, from the second WTRU-to-WTRU relay WTRU, a PC5-S response message which includes (i) a second MAC address of the source-end WTRU, and/or (ii) a second MAC address of the second WTRU-to-WTRU relay WTRU.

60. The first WTRU-to-WTRU relay WTRU of claim 59, wherein the processor, memory, and transceiver are configured to:
determine at least one of the first MAC address of the source-end WTRU and/or the second MAC address of the second WTRU-to-WTRU relay WTRU conflicts with any other MAC address stored in a mapping table at the first WTRU-to-WTRU relay WTRU.

61. The first WTRU-to-WTRU relay WTRU of claim 59, wherein the processor, memory, and transceiver are configured to:
determine the second MAC address of the source-end WTRU and the second MAC address of the second WTRU-to-WTRU relay WTRU do not conflict with any other MAC address stored in a mapping table at the first WTRU-to-WTRU relay WTRU.

62. The first WTRU-to-WTRU relay WTRU of claim 59, wherein the PC5-S request message includes information indicating the first MAC address of the source-end WTRU conflicts with the other MAC address and an identifier of the source-end WTRU.

63. The first WTRU-to-WTRU relay WTRU of claim 59, wherein the PC5-S request message includes information indicating the first MAC address of the second WTRU-to-WTRU relay WTRU conflicts with the other MAC address and an identifier of the second WTRU-to-WTRU relay WTRU.

64. The first WTRU-to-WTRU relay WTRU of claim 59, wherein the processor, memory, and transceiver are configured to:
send, to a third WTRU-to-WTRU relay WTRU, another DCR message.

65. The first WTRU-to-WTRU relay WTRU of claim 64, wherein the other DCR message is associated with establishing a PC5 link between the source-end WTRU and a target-end WTRU via at least the first WTRU-to-WTRU relay WTRU and the third WTRU-to-WTRU relay WTRU.

66. The first WTRU-to-WTRU relay WTRU of claim 59, wherein the DCR message is associated with establishing a PC5 link between the source-end WTRU and a target-end WTRU via at least the first WTRU-to-WTRU relay WTRU and the second WTRU-to-WTRU relay WTRU.

67. The first WTRU-to-WTRU relay WTRU of claim 59, wherein the information indicating the first MAC address of the source-end WTRU and/or the first MAC address of the second WTRU-to-WTRU relay WTRU conflicts with another MAC address is a cause code.

68. The first WTRU-to-WTRU relay WTRU of claim 59, wherein the information indicating the first MAC address of the source-end WTRU and/or the first MAC address of the second WTRU-to-WTRU relay WTRU conflicts with another MAC address includes an identifier of the source-end WTRU and/or the second WTRU-to-WTRU relay WTRU.

69. A method implemented by a first wireless transmit/receive unit-to-wireless transmit/receive unit (WTRU-to-WTRU) relay WTRU, the method comprising:
receiving, from a second WTRU-to-WTRU relay WTRU, a direct connection request (DCR) message;
sending, to the second WTRU-to-WTRU relay WTRU, a direct security mode (DSM) command message;
receiving, from the second WTRU-to-WTRU relay WTRU, a DSM complete message which includes information indicating (i) a first Medium Access Control (MAC) address of a source-end WTRU, and/or (ii) a first MAC address of the second WTRU-to-WTRU relay WTRU;
sending, to the second WTRU-to-WTRU relay WTRU, a PC5-S request message which includes information indicating the first MAC address of the source-end WTRU and/or the first MAC address of the second WTRU-to-WTRU relay WTRU conflicts with another MAC address; and
receiving, from the second WTRU-to-WTRU relay WTRU, a PC5-S response message which includes (i) a second MAC address of the source-end WTRU, and/or (ii) a second MAC address of the second WTRU-to-WTRU relay WTRU.

70. The method of claim 69, further comprising:
determine at least one of the first MAC address of the source-end WTRU and/or the second MAC address of the second WTRU-to-WTRU relay WTRU conflicts with any other MAC address stored in a mapping table at the first WTRU-to-WTRU relay WTRU.

71. The method of claim 69, further comprising:
determine the second MAC address of the source-end WTRU and the second MAC address of the second WTRU-to-WTRU relay WTRU do not conflict with any other MAC address stored in a mapping table at the first WTRU-to-WTRU relay WTRU.

72. The method of claim 69, wherein the PC5-S request message includes information indicating the first MAC address of the source-end WTRU conflicts with the other MAC address and an identifier of the source-end WTRU.

73. The method of claim 69, wherein the PC5-S request message includes information indicating the first MAC address of the second WTRU-to-WTRU relay WTRU conflicts with the other MAC address and an identifier of the second WTRU-to-WTRU relay WTRU.

74. The method of claim 69, further comprising:
sending, to a third WTRU-to-WTRU relay WTRU, another DCR message.

75. The method of claim 64, wherein the other DCR message is associated with establishing a PC5 link between the source-end WTRU and a target-end WTRU via at least the first WTRU-to-WTRU relay WTRU and the third WTRU-to-WTRU relay WTRU.

76. The method of claim 59, wherein the DCR message is associated with establishing a PC5 link between the source-end WTRU and a target-end WTRU via at least the first WTRU-to-WTRU relay WTRU and the second WTRU-to-WTRU relay WTRU.

77. The method of claim 69, wherein the information indicating the first MAC address of the source-end WTRU and/or the first MAC address of the second WTRU-to-WTRU relay WTRU conflicts with another MAC address is a cause code.

78. The method of claim 69, wherein the information indicating the first MAC address of the source-end WTRU and/or the first MAC address of the second WTRU-to-WTRU relay WTRU conflicts with another MAC address includes an identifier of the source-end WTRU and/or the second WTRU-to-WTRU relay WTRU.
